(19) United States
(12) Patent Application Publication
(10) Pub. No.: US 2021/0092390 A1
(43) Pub. Date: Mar. 25, 2021

(54) METHODS AND APPARATUSES FOR PREDICTION REFINEMENT WITH OPTICAL FLOW IN REFERENCE PICTURE RESAMPLING

(71) Applicant: ALIBABA GROUP HOLDING LIMITED, George Town (KY)

(72) Inventors: Jie CHEN, Beijing (CN); Jiancong LUO, San Mateo, CA (US); Ruling LIAO, Beijing (CN); Yan YE, San Mateo, CA (US)

(21) Appl. No.: 17/015,726

(22) Filed: Sep. 9, 2020

Related U.S. Application Data
(60) Provisional application No. 62/904,224, filed on Sep. 23, 2019.
(60) Provisional application No. 62/909,647, filed on Oct. 2, 2019.

(51) Int. Cl. H04N 19/132; H04N 19/176; H04N 19/105; H04N 19/30; H04N 19/186

(52) U.S. Cl. CPC H04N 19/132; H04N 19/176; H04N 19/186; H04N 19/30; H04N 19/105

(57) ABSTRACT

The disclosed embodiments provide methods and apparatuses for reference picture resampling in video coding. A disclosed method includes: in response to receiving a sample block in a reference picture, mapping a boundary sample of the sample block to a mapped coordinate outside the sample block; determining, in the reference picture, a reference sample including the mapped coordinate; determining a gradient based on the reference sample; and refining, based on the gradient, the sample block for prediction.

### CROSS-REFERENCE TO RELATED APPLICATIONS

The present disclosure claims priority to U.S. provisional application No. 62/904,224, filed on Sep. 23, 2019, and U.S. provisional application No. 62/909,647, filed on Oct. 2, 2019, both of which are incorporated herein by reference in their entireties.

### TECHNICAL FIELD

The present disclosure generally relates to video processing, and more particularly, to applying prediction refinement with optical flow (PROF) in reference picture resampling.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

The embodiments of present disclosure provide methods and apparatuses for video processing. In an aspect, a video processing method is provided. The method includes: in response to receiving a sample block in a reference picture, mapping a boundary sample of the sample block to a mapped coordinate outside the sample block; determining, in the reference picture, a reference sample including the mapped coordinate; determining a gradient based on the reference sample; and refining, based on the gradient, the sample block for prediction.

In another aspect, an apparatus for video processing is provided. The apparatus includes a memory configured to store a set of instructions and one or more processors communicatively coupled to the memory and configured to execute the set of instructions to cause the apparatus to perform: in response to receiving a sample block in a reference picture, mapping a boundary sample of the sample block to a mapped coordinate outside the sample block; determining, in the reference picture, a reference sample including the mapped coordinate; determining a gradient based on the reference sample; and refining, based on the gradient, the sample block for prediction.

In another example embodiment, a non-transitory computer-readable medium is provided, which stores a set of instructions that is executable by at least one processor of an apparatus to cause the apparatus to perform a method. The method includes: in response to receiving a sample block in a reference picture, mapping a boundary sample of the sample block to a mapped coordinate outside the sample block; determining, in the reference picture, a reference sample including the mapped coordinate; determining a gradient based on the reference sample; and refining, based on the gradient, the sample block for prediction.

In another example embodiment, a non-transitory computer-readable medium is provided, which stores a set of instructions that is executable by at least one processor of an apparatus to cause the apparatus to perform a method. The method includes: in response to receiving a sample block in a reference picture, mapping, based on a scaling factor, a boundary sample of the sample block to a position outside the sample block; determining an integer sample based on the position; determining a gradient based on the integer sample; and refining, based on the gradient, the sample block for prediction.

In another example embodiment, a non-transitory computer-readable medium is provided, which stores a set of instructions that is executable by at least one processor of an apparatus to cause the apparatus to perform a method. The method includes: in response to receiving a sample block in a reference picture, determining an extended sample by copying a value of a boundary sample of the sample block to a position outside the sample block in the reference picture; determining a gradient based on the extended sample; and refining, based on the gradient, the sample block for prediction.

In another example embodiment, a non-transitory computer-readable medium is provided, which stores a set of instructions that is executable by at least one processor of an apparatus to cause the apparatus to perform a method. The method includes: in response to receiving a sample block in a reference picture, determining a gradient associated with a non-boundary sample of the sample block; determining a boundary gradient associated with a boundary sample of the sample block as the gradient associated with the non-boundary sample; and refining, based on the boundary gradient, the sample block for prediction.

### BRIEF DESCRIPTION OF THE DRAWINGS

Embodiments and various aspects of present disclosure are illustrated in the following detailed description and the accompanying figures. Various features shown in the figures are not drawn to scale.

FIG. 1 is a schematic diagram illustrating structures of an example video sequence, according to some embodiments of the present disclosure.

FIG. 2A illustrates a schematic diagram of an example encoding process of a hybrid video coding system, consistent with embodiments of the disclosure.

FIG. 2B illustrates a schematic diagram of another example encoding process of a hybrid video coding system, consistent with embodiments of the disclosure.

FIG. 3A illustrates a schematic diagram of an example decoding process of a hybrid video coding system, consistent with embodiments of the disclosure.

FIG. 3B illustrates a schematic diagram of another example decoding process of a hybrid video coding system, consistent with embodiments of the disclosure.

FIG. 4 illustrates a block diagram of an example apparatus for encoding or decoding a video, according to some embodiments of the present disclosure.

FIG. 5 is a schematic diagram illustrating an example scenario where a currently coded picture and its reference pictures may have different resolutions, according to some embodiments of the present disclosure.

FIG. 6 is a schematic diagram illustrating example sub-block-based motion and sample-based affine motion, according to some embodiments of the present disclosure.

FIGS. 7A-7B are schematic diagrams illustrating example samples in gradient calculation, according to some embodiments of the present disclosure.

FIG. 8 is a schematic diagram illustrating example samples in gradient calculation in a reference picture resampling (RPR) case, according to some embodiments of the present disclosure.

FIG. 9 is a schematic diagram illustrating first example samples in gradient calculation, according to some embodiments of the present disclosure.

FIG. 10 is a schematic diagram illustrating second example samples in gradient calculation, according to some embodiments of the present disclosure.

FIG. 11 is a schematic diagram illustrating third example samples in gradient calculation, according to some embodiments of the present disclosure.

FIG. 12 is a schematic diagram illustrating fourth example samples in gradient calculation, according to some embodiments of the present disclosure.

FIG. 13 illustrates a flowchart of an example process for video processing, according to some embodiments of this disclosure.

FIG. 14 illustrates a flowchart of an example process for video processing, according to some embodiments of this disclosure.

FIG. 15 illustrates a flowchart of an example process for video processing, according to some embodiments of this disclosure.

FIG. 16 illustrates a flowchart of an example process for video processing, according to some embodiments of this disclosure.

### DETAILED DESCRIPTION

Reference can now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the invention. Instead, they are merely examples of apparatuses and methods consistent with aspects related to the invention as recited in the appended claims. Particular aspects of present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

In order to achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recently and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture” or “target picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the target picture.

A picture coded without referencing another picture (i.e., it is its own reference picture) is referred to as an “I-picture.” A picture coded using a previous picture as a reference picture is referred to as a “P-picture.” A picture coded using both a previous picture and a future picture as reference pictures (i.e., the reference is “bi-directional”) is referred to as a “B-picture.”

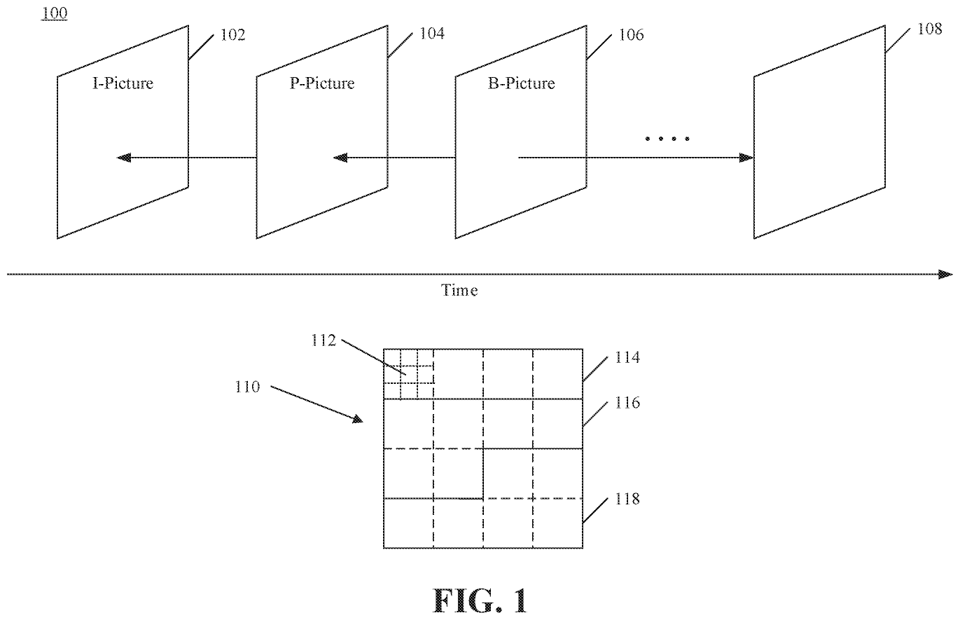

FIG. 1 illustrates structures of an example video sequence 100, according to some embodiments of the present disclosure. Video sequence 100 can be a live video or a video having been captured and archived. Video 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) can be not immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128-128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266NVC). Any operation performed to a basic processing unit can be repeatedly performed to each of its luma and chroma components.

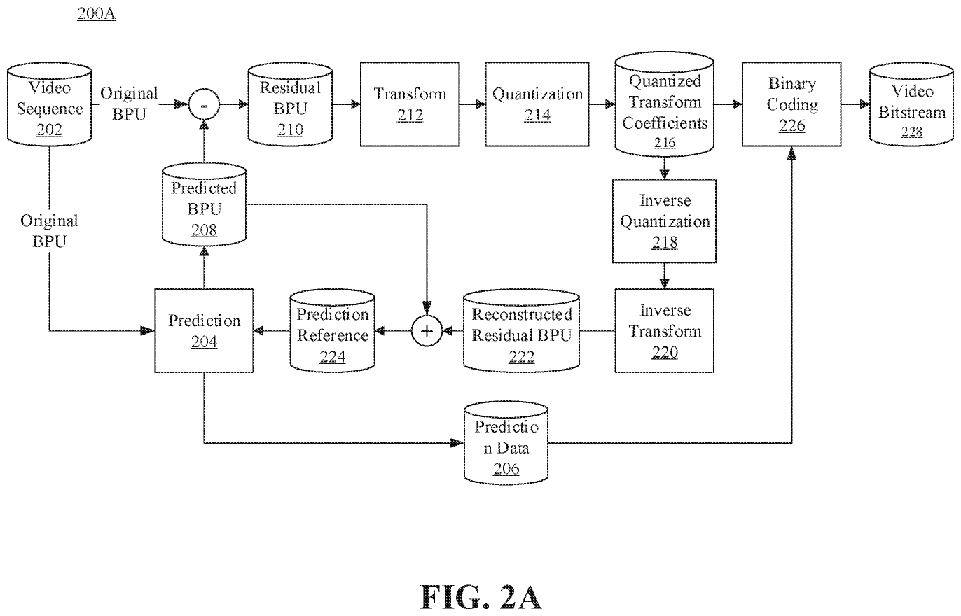

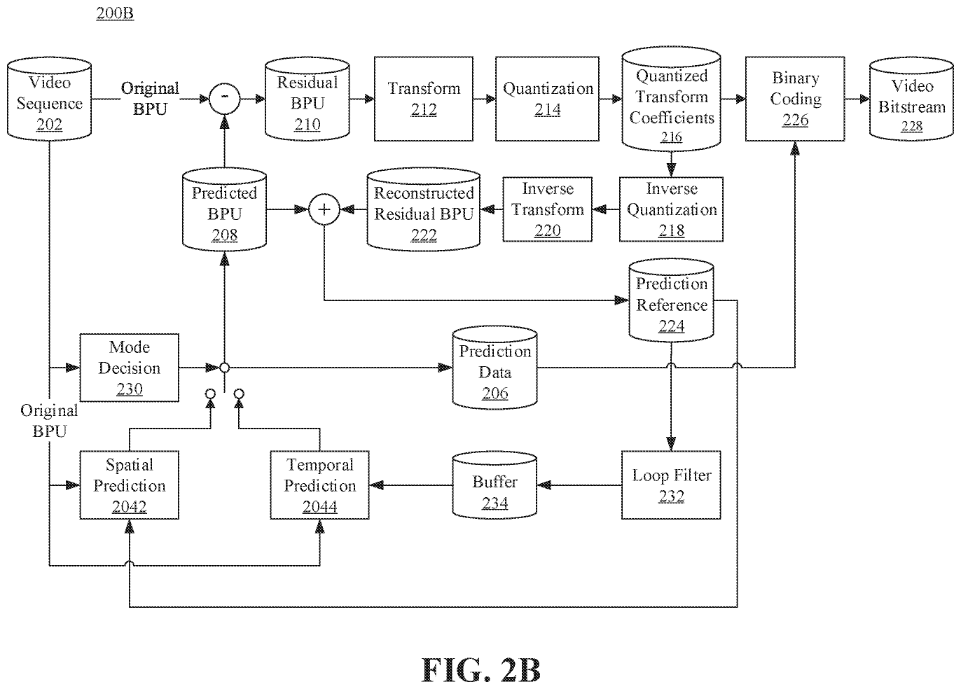

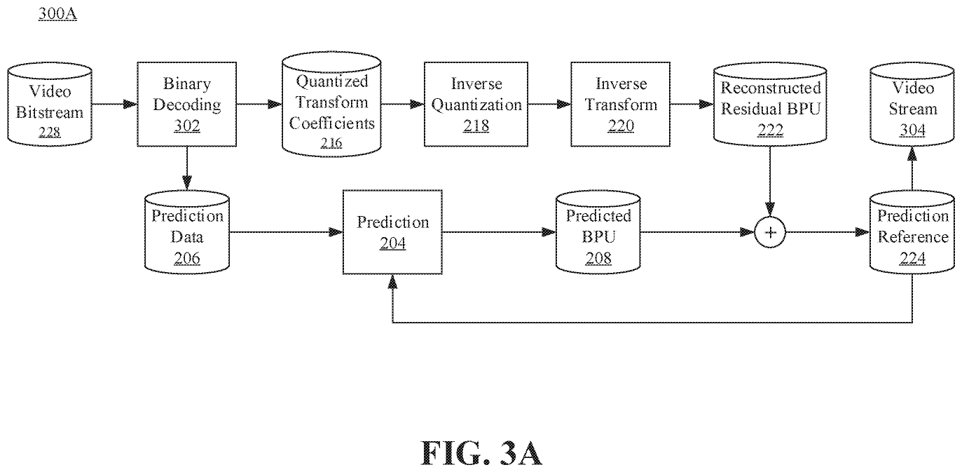

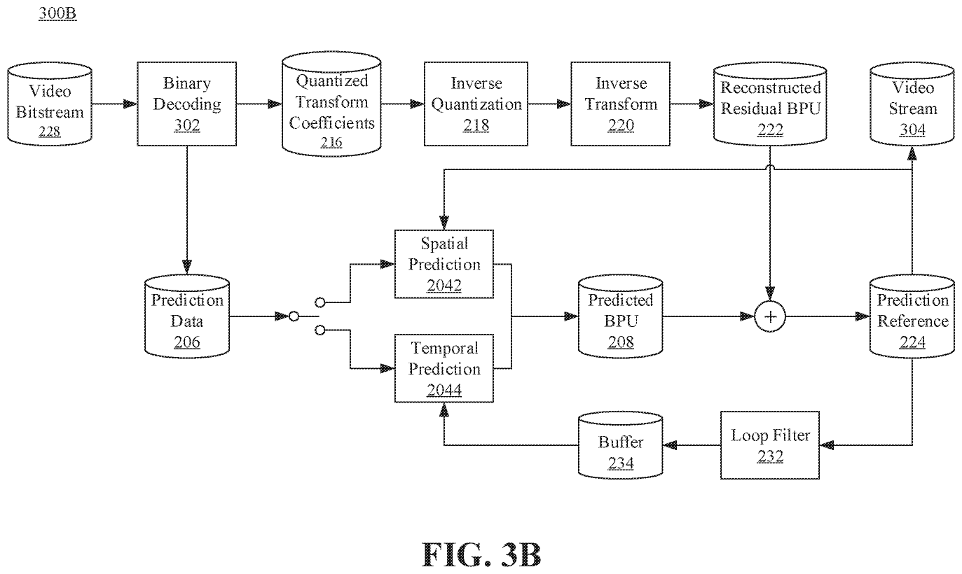

Video coding has multiple stages of operations, examples of which are shown in FIGS. 2A-2B and FIGS. 3A-3B. For each stage, the size of the basic processing units can still be too large for processing, and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266NVC), and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which is shown in FIGS. 2A-2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266NVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266NVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an example encoding process 200A, consistent with embodiments of the disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224, and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization parameter”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization parameter or any other parameter of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, parameters of the prediction operation, a transform type at transform stage 212, parameters of the quantization process (e.g., quantization parameters), an encoder control parameter (e.g., a bitrate control parameter), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another example encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the target BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the target BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at temporal prediction stage 2044, the encoder can perform the inter prediction. For an original BPU of a target picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the target picture. For example, the search window can be centered at a location having the same coordinates in the reference picture as the original BPU in the target picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the target picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the target picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the target picture. For example, picture 104 in FIG. 1 is a unidirectional inter-predicted picture, in which the reference picture (i.e., picture 102) precedes picture 104. Bidirectional inter predictions can use one or more reference pictures at both temporal directions with respect to the target picture. For example, picture 106 in FIG. 1 is a bidirectional inter-predicted picture, in which the reference pictures (i.e., pictures 104 and 108) are at both temporal directions with respect to picture 104.

Still referring to the forward path of process 200B, after spatial prediction stage 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the target BPU that has been encoded and reconstructed in the target picture), the encoder can directly feed prediction reference 224 to spatial prediction stage 2042 for later usage (e.g., for extrapolation of a next BPU of the target picture). If the inter prediction mode has been selected in the forward path, after generating prediction reference 224 (e.g., the target picture in which all BPUs have been encoded and reconstructed), the encoder can feed prediction reference 224 to loop filter stage 232, at which the encoder can apply a loop filter to prediction reference 224 to reduce or eliminate distortion (e.g., blocking artifacts) introduced by the inter prediction. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer”) for later use (e.g., to be used as an inter-prediction reference picture for a future picture of video sequence 202). The encoder can store one or more reference pictures in buffer 234 to be used at temporal prediction stage 2044. In some embodiments, the encoder can encode parameters of the loop filter (e.g., a loop filter strength) at binary coding stage 226, along with quantized transform coefficients 216, prediction data 206, and other information.

FIG. 3A illustrates a schematic diagram of an example decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIGS. 2A-2B), generally, video stream 304 is not identical to video sequence 202. Similar to processes 200A and 200B in FIGS. 2A-2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, the decoder can depacketize video bitstream 228 before feeding it to binary decoding stage 302.

FIG. 3B illustrates a schematic diagram of another example decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044, and additionally includes loop filter stage 232 and buffer 234.

In process 300B, for an encoded basic processing unit (referred to as a “current BPU” or “target BPU”) of an encoded picture (referred to as a “current picture” or “target picture”) that is being decoded, prediction data 206 decoded from binary decoding stage 302 by the decoder can include various types of data, depending on what prediction mode was used to encode the target BPU by the encoder. For example, if intra prediction was used by the encoder to encode the target BPU, prediction data 206 can include a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by the encoder to encode the target BPU, prediction data 206 can include a prediction mode indicator (e.g., a flag value) indicative of the inter prediction, parameters of the inter prediction operation, or the like. The parameters of the inter prediction operation can include, for example, the number of reference pictures associated with the target BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the target BPU is decoded using the intra prediction at spatial prediction stage 2042, after generating prediction reference 224 (e.g., the decoded target BPU), the decoder can directly feed prediction reference 224 to spatial prediction stage 2042 for later usage (e.g., for extrapolation of a next BPU of the target picture). If the target BPU is decoded using the inter prediction at temporal prediction stage 2044, after generating prediction reference 224 (e.g., a reference picture in which all BPUs have been decoded), the encoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, when the prediction mode indicator of prediction data 206 indicates that inter prediction was used to encode the target BPU, prediction data can further include parameters of the loop filter (e.g., a loop filter strength).

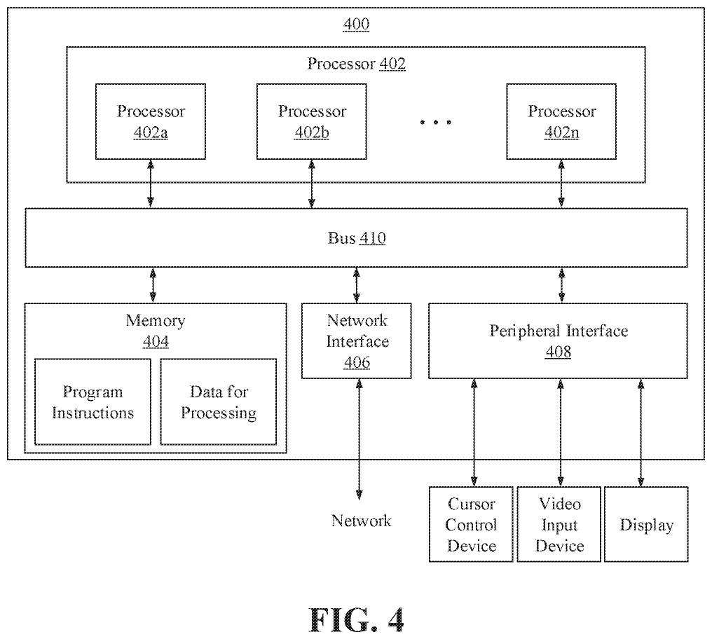

FIG. 4 is a block diagram of an example apparatus 400 for encoding or decoding a video, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, an near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface communicatively coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

In the quantization and inverse quantization functional blocks (e.g., quantization 214 and inverse quantization 218 of FIG. 2A or FIG. 2B, inverse quantization 218 of FIG. 3A or FIG. 3B), a quantization parameter (QP) is used to determine the amount of quantization (and inverse quantization) applied to the prediction residuals. Initial QP values used for coding of a picture or slice can be signaled at the high level, for example, using init_qp_minus26 syntax element in the Picture Parameter Set (PPS) and using slice_qp_delta syntax element in the slice header. Further, the QP values can be adapted at the local level for each CU using delta QP values sent at the granularity of quantization groups.

One aspect of the Versatile Video Coding (VVC) standard is to offer video conferencing applications the ability to accommodate diverse devices and network conditions, and rapid adaptability to varying network environments. The varying network environment can include rapidly decreasing encoded bit rate when network conditions deteriorate and rapidly increasing video quality when network conditions improve. The expected video quality can vary from very low to very high. The VVC standard can also support fast representation switching in adaptive streaming services that offer multiple representations of the same content, in which each representation can have different properties (e.g., spatial resolution or sample bit depth). During switching from one representation to another (e.g., switching from one resolution to another), the VVC standard can enable the use of an efficient prediction structure without compromising the fast and seamless switching capability.

The aim of adaptive resolution change (ARC) is to allow a stream to change spatial resolution between coded pictures within the same video sequence without requiring a new Instantaneous Decoder Refresh (IDR) picture or multi-layers as in a scalable video codec. Instead, at a switch point, ARC allows pictures to change their resolution and to be predicted from reference pictures with the same resolution (if available) or with a different resolution. In ARC, reference picture resampling can be invoked when a reference picture is of a different resolution from the target picture. For such a reason, ARC can also be referred to as “reference picture resampling” (RPR), and these two terms are used herein interchangeably.

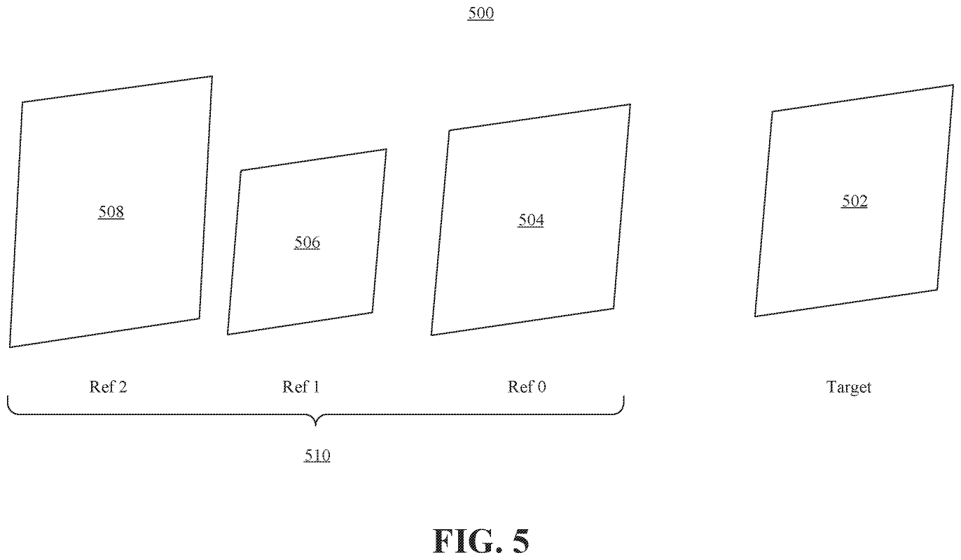

Consistent with some embodiments of this disclosure, FIG. 5 is a schematic diagram illustrating an example scenario 500 where resolutions of reference pictures may be different from the resolution of a currently coded picture, according to some embodiments of the present disclosure. In FIG. 5, a target picture 502 is being encoded or decoded, such as by a codec as illustrated and described in FIGS. 2A-2B or 3A-3B. Reference pictures 504, 506, and 508 are three example reference pictures, each of which can either represent a single reference picture or a group of reference pictures. For example, reference pictures 504-508 can be part of prediction reference 224 in FIGS. 2A-2B or 3A-3B. Reference pictures 504, 506, and 508 can be stored in a decoded picture buffer (DPB), such as buffer 234 in FIGS. 2B and 3B. In FIG. 5, the resolution of reference picture 504 is same as that of target picture 502. The resolutions of reference pictures 506 and 508 are different from that of target picture 502. In some embodiments, after reference pictures 506 and 508 being resampled to the resolution of target picture 502, the codec can perform motion compensated prediction based on reference pictures 506 and 508.

When the resolution of a reference picture is different from that of a target picture (e.g., in scenario 500), one way to generate a motion compensated prediction signal is to perform picture-based resampling, where the reference picture can be resampled to the same resolution as the target picture, and then be applied with motion compensation based on motion vectors. The motion vectors can be scaled if they are sent in units before resampling being performed, or not scaled if they are sent in units after resampling being applied. With the picture-based resampling, information loss can occur during the resampling operation before motion compensated interpolation, especially in reference picture down-sampling (e.g., the resolution of the reference picture being larger than that of the target picture) because down-sampling is usually achieved with a low-pass filtering followed by decimation.

Another way to generate the motion compensated prediction signal when the resolution of the reference picture is different from that of the target picture is to perform block-based resampling, where resampling can be performed at the block level. In the block-based resampling, one or more reference pictures used by the current block can be examined, and if at least one of the reference pictures has a different resolution from that of the target picture, the block-based resampling can be performed in combination of a sub-pel (or “sub-pixel”) motion compensated interpolation process. Combining the resampling and motion compensated interpolation into one filtering operation can reduce the above-described information loss. In an example, a motion vector of a current block can have half-pel precision in one dimension (e.g., the horizontal dimension), and the width of a reference picture can be twice of the width of a target picture. In the picture-level resampling, the width of the reference picture can be reduced by half to match the width of the target picture, and half-pel motion interpolation can be performed. As a comparison, in the block-based resampling, odd positions in the reference picture can be directly fetched to form a reference block at half-pel precision.

In some embodiments, a coding tool, “prediction refinement with optical flow” (PROF), can be used for improving accuracy of affine motion compensated prediction. PROF can refine sub-block-based affine motion compensated prediction with an optical flow. Affine motion model parameters can be used to derive a motion vector of each sample position in a CU. However, due to the high complexity and memory access bandwidth for generating sample-by-sample affine motion compensated prediction, the current VVC standard adopts a sub-block-based affine motion compensation method in which a CU is divided into 4×4 sub-blocks, each sub-block being assigned with a motion vector (MV) derived from control-point MVs of the affine CU. The sub-block-based affine motion compensation can be a trade-off between coding efficiency, coding complexity, and memory access bandwidth. It may lose some prediction accuracy due to the sub-block-based prediction compared with sample-based motion compensated prediction.

Consistent with the disclosed embodiments, to achieve a finer granularity of affine motion compensation, PROF can be applied after regular sub-block-based affine motion compensation based on the optical flow. In some embodiments, PROF can include four steps. In the first step, the sub-block-based affine motion compensation can be performed to generate sub-block prediction I(i,j) for a sample location (i,j). In the second step, spatial gradients gₓ(i,j) and g_{y}(i,j) of I(i,j) can be calculated at each sample location using a 3-tap filter [−1, 0, 1], such as based on Eqs. (1) to (2):

gₓ(i,j)=(I(i+1,j)>>shift1)−(I(i−1,j)>>shift1) Eq. (1)

g_{y}(i,j)=(I(i,j+1)>>shift1)−(I(i,j−1)>>shift1) Eq. (2)

where shift1 is used to control the precision of gₓ(i,j) and g_{y}(i,j). The sub-block (e.g., 4×4) prediction can be extended by one sample on each side for the gradient calculation. To avoid additional memory bandwidth and additional interpolation computation, those extended samples on the extended borders can be copied from the nearest integer pixel position in the reference picture.

In the third step of PROF, luma prediction refinement can be calculated based on an optical flow equation, such as Eq. (3):

ΔI(i,j)=gₓ(i,j)*Δvₓ(i,j)+g_{y}(i,j)*Δv_{y}(i,j) Eq. (3)

where Δv(i,j) is a difference between a sample MV computed for the sample location (i,j), denoted by v(i,j), and a sub-block MV of the sub-block to which the sample location (i,j) belongs.

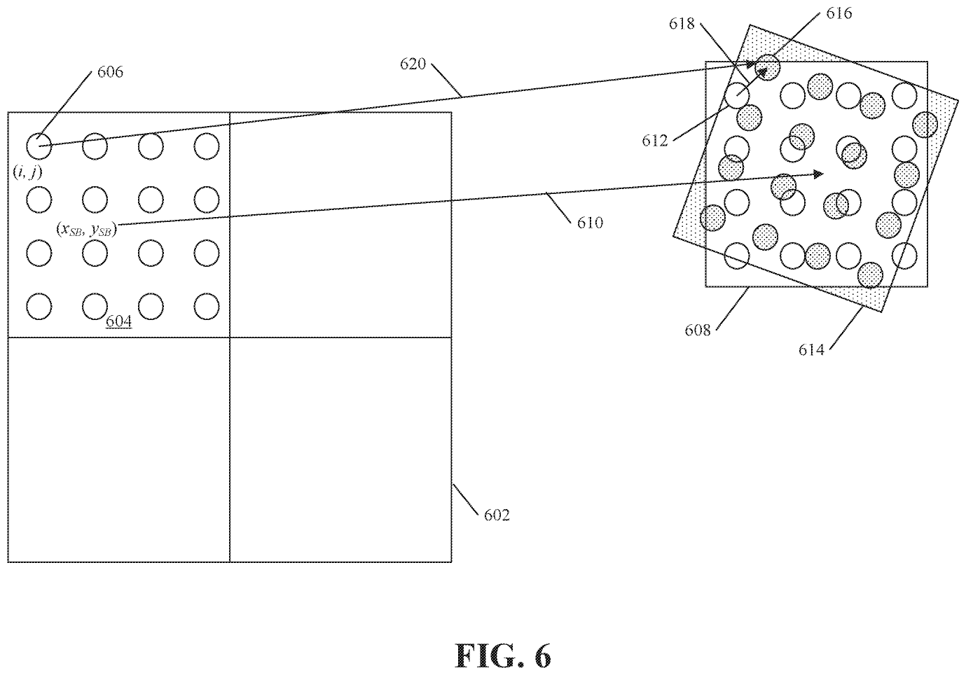

Consistent with some embodiments of this disclosure, Δv(i,j) can be illustrated in FIG. 6, which is a schematic diagram illustrating example sub-block-based motion and sample-based affine motion, according to some embodiments of the present disclosure. In FIG. 6, reference coding unit (CU) 602 is divided into 2.2 sub-blocks, including a sub-block 604. Sub-block 604 includes a sub-block sample 606 at a location (i,j). Sub-block 604 corresponds to block 608 (with no shades) that is in a current CU corresponding to reference CU 602. A sub-block motion vector 610 connects sub-block 604 and block 608, such as by their center points. For example, as shown in FIG. 6, sub-block motion vector 610 starts at a center point at location (x_{SB}, y_{SB}) in sub-block 604 and points to a center point of block 608. By moving sub-block sample 606 in accordance with sub-block motion vector 610, a sub-block prediction 612, as represented by a white circle in FIG. 6, can be determined in block 608.

By an affine transformation, block 608 can be transformed to an affine block 614. In such an affine transformation, sub-block prediction 612 can be projected to an affine sub-block prediction 616, as represented by a circle filled with dot patterns in FIG. 6. A sample motion vector offset 618 connects sub-block prediction 612 and affine sub-block prediction 616. A sample motion vector 620 connects sub-block sample 606 and affine sub-block prediction 616. In FIG. 6, sample motion vector 620 can be v(i,j) in Eq. (3), and sample motion vector offset 618 can be Δv(i,j) in Eq. (3).

Because affine model parameters and the sample location (e.g., location of sub-block sample 606) relative to the sub-block center (e.g., the center of sub-block 604) are not changed across sub-blocks (e.g., sub-blocks of reference CU 602), Δv(i,j) in Eq. (3) can be calculated for a first sub-block (e.g., sub-block 604), and then be reused for other sub-blocks in the same CU. Let dx(i,j) and dy(i,j) denote horizontal and vertical offsets from the sample location (i,j) to the center point (x_{SB},y_{SB}) of the sub-block, respectively, Δv(x, y) can be derived based on Eqs. (4) to (5):

$$\begin{matrix}\{ \begin{matrix}dx ( i , j ) = i - {x}_{SB} \\ dy ( i , j ) = j - {y}_{SB}\end{matrix} & Eq . ( 4 ) \\ \{ \begin{matrix}{Δ v}_{x} ( i , j ) = C * dx ( i , j ) + D * dy ( i , j ) \\ {Δ v}_{y} ( i , j ) = E * dx ( i , j ) + F * dy ( i , j )\end{matrix} & Eq . ( 5 )\end{matrix}$$

In order to keep accuracy, (x_{SB}, y_{SB}) can be calculated as ((WSB−1)/2, (HSB−1)/2), where WSB and HSB are width and height of the sub-block, respectively.

In some embodiments, for a 4-parameter affine model, the coefficients C, D, E, and F in Eq. (5) can be determined based on Eq. (6):

$$\{ \begin{matrix}C = F = \frac{{v}_{1 x} - {v}_{0 x}}{w} \\ E = - D = \frac{{v}_{1 y} - {v}_{0 y}}{w}\end{matrix} \qquad Eq . ( 6 )$$

In some embodiments, for 6-parameter affine model, the coefficients C, D, E, and F in Eq. (5) can be determined based on Eq. (7):

$$\{ \begin{matrix}C = \frac{{v}_{1 x} - {v}_{0 x}}{w} \\ D = \frac{{v}_{2 x} - {v}_{0 x}}{h} \\ E = \frac{{v}_{1 y} - {v}_{0 y}}{w} \\ F = \frac{{v}_{2 y} - {v}_{0 y}}{h}\end{matrix} \qquad Eq . ( 7 )$$

where (v₀ₓ, v_{0y}), (v₁ₓ, v_{1y}), (v₂ₓ, v_{2y}) are respectively the top-left, top-right and bottom-left control-point motion vectors, and w and h are respectively the width and height of the CU.

In the fourth step of PROF, the luma prediction refinement ΔI(i,j) can be added to the sub-block prediction I(i,j). The final prediction I′ can be generated based on Eq. (8):

I′(i,j)=I(i,j)+ΔI(i,j) Eq. (8)

In some embodiments, PROF is not applied to an affine coded CU. In a first example, all control-point MVs are the same, which indicates the CU only has translational motion. In a second example, the affine motion parameters are greater than a specified limit because the sub-block-based affine motion compensation (MC) is degraded to CU-based MC to avoid large memory access bandwidth requirement.

Consistent with some embodiments of this disclosure, a fast encoding method can be applied to reduce the encoding complexity of affine motion estimation with PROF. PROF is not applied at affine motion estimation stage in following two situations. In the first situation, if the current CU is not the root block and its parent block does not select the affine mode as its best mode, PROF is not applied because the possibility for the current CU to select the affine mode as best mode is low. In the second situation, if the magnitude of four affine parameters (C, D, E, F) (as described in Eqs. (5) to (7)) are all smaller than a predefined threshold and the target picture is not a low delay picture, PROF is not applied because the improvement introduced by PROF is small. In this way, the affine motion estimation with PROF can be accelerated. Then, the prediction refinement ΔI(i,j) can be added to the sub-block prediction I(i,j). The final prediction I′ is generated based on Eq. (8).

To apply PROF, the gradient of a 4×4 sub-block affine motion prediction can be calculated at each sample location. To get the gradient of the sample located on the boundary of 4×4 sub-block, the sub-block (e.g., 4×4) prediction needs to be extended by one sample on each side. Therefore, a 6×6 prediction block can be used for gradient calculation of a 4×4 sub-block. However, extending the prediction block size increases the number of samples that need to be interpolated and requires higher memory access bandwidth. Thus, to avoid additional interpolation and reduce memory access bandwidth, in some embodiments the values of extended samples (e.g., boundary samples of the 6×6 prediction block) can be directly copied from the nearest integer samples in the reference picture.

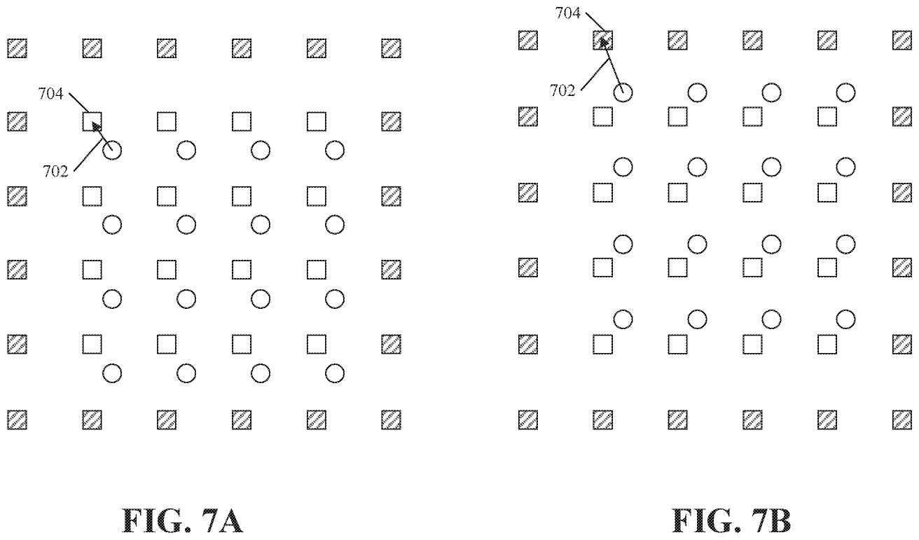

Consistent with some embodiments of this disclosure, FIGS. 7A-7B are schematic diagrams illustrating example samples in gradient calculation, according to some embodiments of the present disclosure. FIGS. 7A-7B show relative positions of current prediction of 4×4 sub-blocks with respect to reference samples. In FIGS. 7A-7B, circles represent prediction samples, and squares represent reference samples, in which white squares represent integer samples out of the boundary of reference samples that are located at integer positions, and pattern-filled squares represent integer samples that are used for gradient calculation of boundary samples of sub-block prediction. FIGS. 7A-7B also show a fractional motion vector 702, represented as (xFrac, yFrac). According to fractional motion vector 702, the integer samples can be used for gradient calculation for the boundary samples.

Assuming that a fractional motion vector of 4-4 sub-blocks is (xFrac, yFrac) and that the position of a top-left integer reference sample 704 is (xInt, yInt), the integer samples on the borders of the block with top-left position can be (xInt+(xFrac>>3)−1, yInt+(yFrac>>3)−1) given the motion vector precision is 1/16 samples, and the width and height can be used to replace the extended prediction samples for gradient calculation of boundary samples of the 4×4 sub-blocks. For example, the width and height can be 4+brdExtSize (e.g., brdExtSize is 2). FIG. 7A shows a case where xFrac>>3 is less than 1 and yFrac>>3 is less than 1. FIG. 7B shows a case where xFrac>>3 is less than 1 and yFrac>>3 is equal to or more than 1.

Replacing the extended prediction samples with integer reference samples reduces the computation cost but increases the inaccuracy of gradient calculated. The inaccuracy become greater when this method is directly applied in a reference picture resampling (RPR) case where the resolution of the reference picture is different from the target picture.

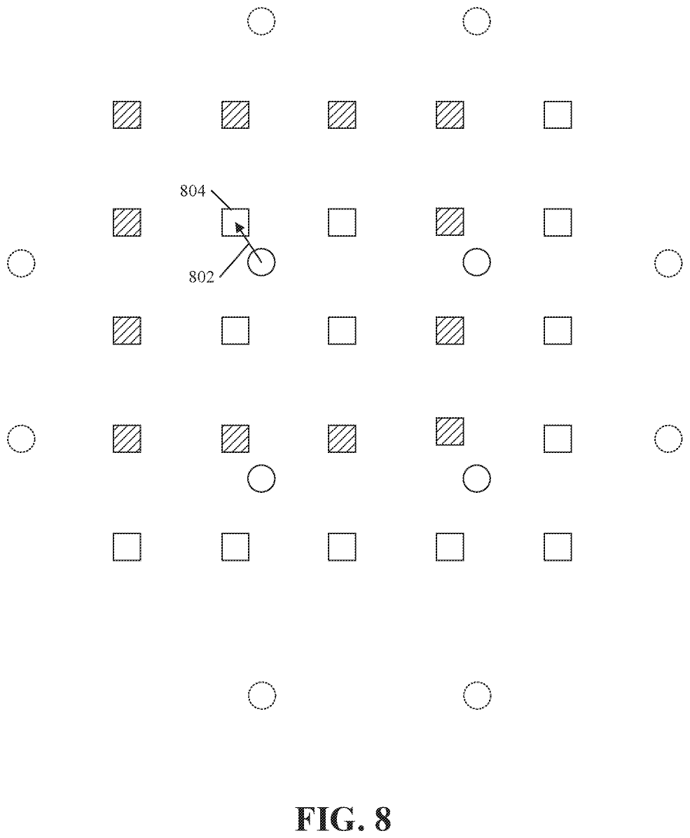

Consistent with some embodiments of this disclosure, FIG. 8 is a schematic diagram illustrating example samples in gradient calculation in an RPR case, according to some embodiments of the present disclosure. In FIG. 8, the scaling ratio is equal to 2. For example, the width and height of a reference picture are twice of the width and height of a target picture, respectively. Assuming the predicted sub-block is 2×2, and a fractional motion vector 802, represented as (xFrac, yFrac), satisfies the condition that xFrac>>3 is less than 1 and yFrac>>3 is less than 1, and that the position of a top-left integer reference sample 804 is (xInt, yInt), the shaded samples (represented as 12 shaded squares in FIG. 8) can be used for boundary gradient calculation. For example, the top-left sample of the shaded samples can be (xInt+(xFrac>>3)−1, yInt+(yFrac>>3)−1), and the width and height of the shaded samples can be 4. However, the extended prediction samples theoretically needed in gradient calculation are shown as dotted circles in FIG. 8, which are far away from the shaded samples. Because this issue, PROF is disabled in VVC Test model (VTM) 6.0 when RPR is used, in which the coding gain of PROF is lost.

This disclosure provides methods and systems for gradient calculation of boundary prediction samples, in which PROF can be enabled in RPR to further improve the coding performance of VVC. In some embodiments, a current block to be predicted can be extended one sample out of the boundary. For example, a w×h prediction block can be extended to be (w+2)×(h+2). Then, positions of the extended samples in a reference picture can be calculated, and the nearest integer reference samples to the position of the extended samples in the reference picture can be obtained for gradient calculation.

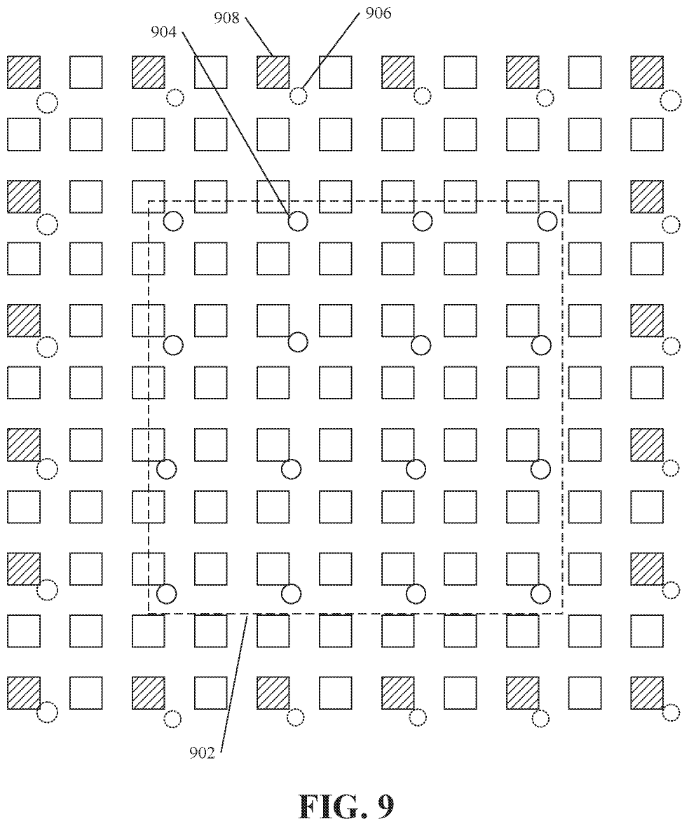

Consistent with some embodiments of this disclosure, FIG. 9 is a schematic diagram illustrating first example samples in gradient calculation, according to some embodiments of the present disclosure. In the example shown in FIG. 9, the scaling ratio is 2. For example, a reference picture is twice of a target picture in horizontal and vertical dimensions. In FIG. 9, white circles represent 4×4 prediction blocks, and squares represent reference samples. As shown in FIG. 9, the 4×4 prediction blocks are extended to 6×6 blocks, in which the extended samples are represented by dotted circles in FIG. 9. The nearest integer reference samples (represented as pattern-filled squares in FIG. 9) of the extended samples can be obtained. By doing so, the nearest integer reference samples and the 4×4 prediction blocks (represented as white circles) can form a 6×6 block to calculate the gradient of the 4×4 prediction blocks.

Consistent with some embodiments of this disclosure, the integer samples for gradient calculation can be determined as follows. Let (x₀, y₀) be the position of a top-left sample of a prediction block in a reference picture, (xᵢ, y₋₁) (i=−1 . . . w, where w is the width of the prediction block) be the position of a sample of the top extended row in the reference picture, (xᵢ, yₕ) (i=−1 . . . w) be the position of a sample of the bottom extended row in the reference picture, (x₋₁, yⱼ) (j=0 . . . h−1, where h is the height of the prediction block) be the position of a sample of the left extended column in the reference picture, and (x_{w}, yⱼ) (j=0 . . . h−1) be the position of a sample of the right extended column in the reference picture. Without loss of generality, the precision of xᵢ and yⱼ can be assumed to be ½\hat{ }10-th pixel herein. An integer position of (x, y) can be represented as (Int_x, Int_y), and a fractional position of (x, y) can be represented as (Frac_x, Frac_y). The resampling ratio of the current block in horizontal and vertical dimensions, hori_scale_fp and vert_scale_fp, as well as parameters stepX, stepY, offX, and offY, can be determined based on the following pseudo codes:

hori_scale_fp = ( ( fRefWidth << 14 ) + ( PicOutputWidthL
>> 1 ) ) / PicOutputWidthL
vert_scale_fp = ( ( fRefHeight << 14 ) + ( PicOutputHeightL
>> 1 ) ) / PicOutputHeightL
stepX = (hori_scale_fp+8)>>4
stepY=(vert_scale_fp+8)>>4
offX=1<<5
offY=1<<5

where fRefWidth and fRefHeight are respectively the width and height of the reference picture, and PicOutputWidthL and PicOutputHeightL are respectively the width and height of the target picture. For ease of explanation without loss of generality, the precision of resampling ratio herein can be 14 bits, which means that 1<<14 represents a resampling ratio equal to 1.

Under such assumptions, for the top extended row (xᵢ, y⁻¹) (i=−1 . . . w), each xᵢ and y₋₁ can be determined based on the following pseudo codes:

y₋₁ = y₀ − stepY
Int_y₋₁= (y₋₁+ offY) >> 10;
Clip Int_y₋₁ to [0,picture height]
Frac_y₋₁ = ((y₋₁+ offY) >>6) &15;
for (j = −1; j < w + 1; j++)
{

xⱼ = x₀ + j*stepX;
Int_xⱼ = (xⱼ + offX) >> 10;
Clip Int_xᵢ to [0,picture width]
Frac_xⱼ = ((xⱼ + offX) >>6) & 15;

}

For the bottom extended row (xᵢ, yₕ) (i=−1 . . . w), each xᵢ and yₕ can be determined based on the following pseudo codes:

yₕ = y₀ + h*stepY
Int_yₕ= (yₕ+ offY) >> 10;
Clip Int_yₕ to [0,picture height]
Frac_yₕ = ((yₕ+ offY) >>6) &15;
for (j = −1; j < w + 1; j++)
{

xⱼ = x₀ + j*stepX;
Int_xⱼ = (xⱼ + offX) >> 10;
Clip Int_xⱼ to [0,picture width]
Frac_xⱼ = ((xⱼ + offX) >>6) & 15;

}

For the left extended column (x₋₁, yⱼ) (j=0 . . . h−1), each yⱼ and x₋₁ can be determined based on the following pseudo codes:

x₋₁ =x₀−stepX;
Int_x₋₁ = (x₋₁+ offX) >> 10;
Clip Int_x₋₁ to [0,picture width]
Frac_x₋₁ = ((x₋₁+ offX) >> 6) & 15;
for (j = 0; j < height; j++)
{

yⱼ = y₀ + j*stepY;
Int_yⱼ = (yⱼ + offY) >> 10;
Clip Int_yⱼ to [0,picture height]
Frac_yⱼ = ((yⱼ + offY) >> 6) & 15;

}

For the right extended column (x_{w}, yⱼ) (j=0 . . . h−1), each yⱼ and x_{w} can be determined based on the following pseudo codes:

x_{w} =x₀+w*stepX;
Int_x_{w} = (x_{w}+ offX) >> 10;
Clip Int_x_{w} to [0,picture width]
Frac_x_{w} = ((x_{w}+ offX) >> 6) & 15;
for (j = 0; j < height; j++)
{

yⱼ = y₀ + j*stepY;
Int_yⱼ = (yⱼ + offY) >> 10;
Clip Int_yⱼ to [0,picture height]
Frac_yⱼ = ((yⱼ + offY) >> 6) & 15;

}

In some embodiments, the clip operation (represented as pseudo code “Clip”) in the above pseudo codes can be skipped or omitted. For an extended sample (xᵢ, yⱼ), the nearest integer reference samples used for gradient calculation of (xᵢ, yⱼ) can be (Int_xᵢ+(Frac_xᵢ>>3), Int_yⱼ+(Frac_yⱼ>>3).

As described above, the current block to be predicted can be extended one sample out of the boundary, after which the position of the extended samples in the reference picture can be calculated. Based on the length of an interpolation filter, a number of additional reference samples can be used to interpolate the prediction samples. For example, for a w×h prediction block, if an 8-tap interpolation filter is used, 3 additional reference samples on the top and left, and 4 additional reference samples on the bottom and right can be fetched, in which the total reference samples to be fetched can be (w+7)×(h+7) if resolution of reference picture is the same as that of the target picture. In some embodiments, additional operations can be performed to obtain the nearest integer reference samples to the position of the extended samples in the reference picture. The nearest integer reference samples can be used for gradient calculation.

In the above-described example embodiments, the locations of the integer reference samples, which replaces the extended prediction samples in gradient calculation, can be based on the scaling ratio. When the scaling ratio is large, the integer reference samples used for gradient calculation can be located outside of the reference sample area that is to be used to interpolate the prediction block. In that case, the above-described example embodiments can increase the memory access bandwidth.

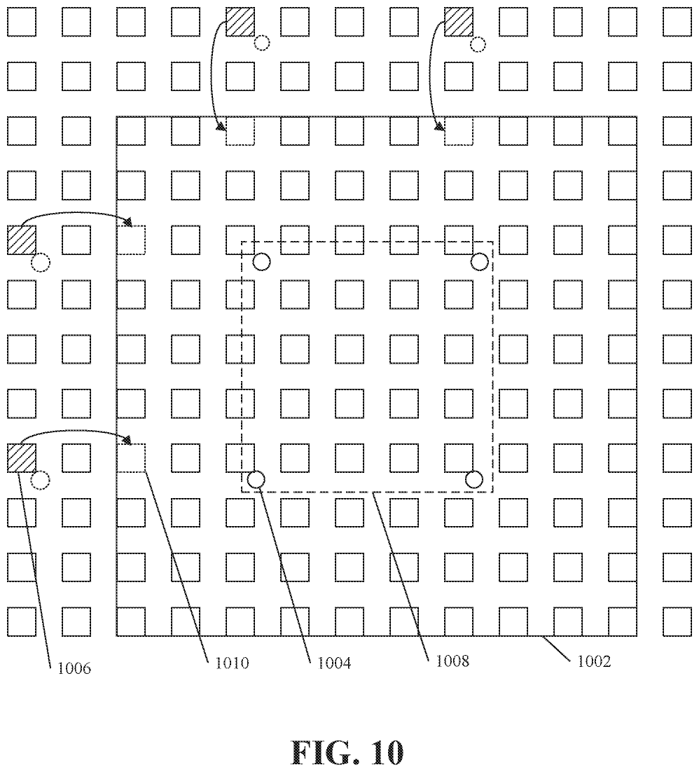

Consistent with some embodiments of this disclosure, the nearest integer reference sample can be further clipped within the reference sample area used for interpolation of the prediction block to limit or avoid bandwidth increase. Consistent with some embodiments of this disclosure, FIG. 10 is a schematic diagram illustrating second example samples in gradient calculation, according to some embodiments of the present disclosure. In the example shown in FIG. 10, the scaling ratio is 4. For example, a reference picture is four times of a target picture in horizontal and vertical dimensions. For ease of explanation without loss of generality, it can be assumed that a 6-tap interpolation filter is used to interpolate the prediction samples in embodiments described in association with FIG. 10.

In FIG. 10, white circles represent prediction blocks, and squares represent reference samples. The reference block used for interpolation is indicated as a box 1002 enclosing the prediction blocks and multiple reference samples, as illustrated in FIG. 10. When the prediction blocks are extended (represented as dotted circles), because the scaling ratio is 4, the nearest integer samples (represented as shaded squares) can be out of the reference block used for regular motion compensation interpolation. In such a case, if the nearest integer samples are to be used for gradient calculation, the bandwidth can be increased. In some embodiments, the nearest integer samples can be clipped within the reference sample area (represented by dotted squares) that is used for interpolation. The clip operation can be represented as arrows in FIG. 10. Clipping a value, as used herein, can refer to an operation of setting the value to an upper limit value if the value exceeds the upper limit value or setting the value to a lower limit value if the value is below the lower limit value.

In some embodiments, the integer samples for gradient calculation can be determined as follows. Let (x₀, y₀) be the position of a top-left sample of a prediction block in a reference picture, (xᵢ, y₋₁) (i=−1 . . . w, where w is the width of the prediction block) be the position of a sample of the first extended row in the reference picture, (xᵢ, yₕ) (i=−1 . . . w) be the position of a sample of the last extended row in the reference picture, (x₋₁, yⱼ) (j=0 . . . h−1, where h is the height of the prediction block) be the position of a sample of the most left extended column in the reference picture, and (x_{w}, yⱼ) (j=0 . . . h−1) be the position of a sample of the most right extended column in the reference picture. For ease of explanation without loss of generality, the precision of xᵢ and yⱼ can be assumed to be ½\hat{ }10-th pixel herein. An integer position of (x, y) can be represented as (Int_x, Int_y), and a fractional position of (x, y) can be represented as (Frac_x, Frac_y). The tap number of an interpolation filter can be represented as tap_num. The resampling ratio of the current block in horizontal and vertical dimensions, hori_scale_fp and vert_scale_fp, parameters stepX, stepY, offX, and offY, as well as integer positions of (x₀, y₀) and (x_{w-1}, yₕ₋₁), can be determined based on the following pseudo codes:

hori_scale_fp = ( ( fRefWidth << 14 ) + ( PicOutputWidthL
>> 1 ) ) / PicOutputWidthL
vert_scale_fp = ( ( fRefHeight << 14 ) + ( PicOutputHeightL
>> 1 ) ) / PicOutputHeightL
stepX = (hori_scale_fp+8)>>4
stepY=(vert_scale_fp+8)>>4
offX=1<<5
offY=1<<5
Int_ y₀= (y₀+ offY) >> 10;
Int_ x₀= (x₀+ offX) >> 10;
Int_ yₕ₋₁= (y₀+(h−1)*stepY+ offY) >> 10;
Int_ x_{w-1}= (x₀+ (w−1)*stepX+offX) >> 10;

where fRefWidth and fRefHieight are respectively the width and height of the reference picture, and PicOutputWidthL and PicOutputHeightL are respectively the width and height of the target picture.

Under such assumptions, for the first extended row (xᵢ, y₋₁) (i=−1 . . . w), each xᵢ can be determined based on the following pseudo codes:

y₋₁ = y₀ − stepY
Int_y₋₁= (y₋₁+ offY) >> 10;
Frac_y₋₁ = ((y₋₁+ offY) >>6) &15;
Clip Int_y₋₁ to [0, picture height]
for (j = −1; j < w + 1; j++)
{

xⱼ = x₀ + j*stepX;
Int_xⱼ = (xⱼ + offX) >> 10;
Frac_xⱼ = ((xⱼ + offX) >>6) & 15;
Clip Int_xⱼ to [0,picture width]

}

For the last extended row (xᵢ, yₕ) (i=−1 . . . w), each xᵢ and yₕ can be determined based on the following pseudo codes:

yₕ = y₀ + h*stepY
Int_yₕ= (yₕ+ offY) >> 10;
Frac_yₕ = ((yₕ+ offY) >>6) &15;
Clip Int_yₕ to [0,picture height]
for (j = −1; j < w + 1; j++)
{

xⱼ = x₀ + j*stepX;
Int_xⱼ = (xⱼ + offX) >> 10;
Frac_xⱼ = ((xⱼ + offX) >>6) & 15;
Clip Int_xⱼ to [0, picture width]

}

For the most left extended column (x₋₁, yⱼ) (j=0 . . . h−1), each yⱼ and x₋₁ can be determined based on the following pseudo codes:

x₋₁ =x₀−stepX;
Int_x₋₁ = (x₋₁+ offX) >> 10
Frac_x₋₁ = ((x₋₁+ offX) >> 6) & 15;
Clip Int_x₋₁ to [0, picture width]
for (j = 0; j < height; j++)
{

yⱼ = y₀ + j*stepY;
Int_yⱼ = (yⱼ + offY) >> 10;
Frac_yⱼ = ((yⱼ + offY) >> 6) & 15;
Clip Int_yⱼ to [0,picture height]

}

For the most right extended column (x_{w}, yⱼ) (j=0 . . . h−1), each yⱼ and x_{w} can be determined based on the following pseudo codes:

x_{w} =x₀+w*stepX;
Int_x_{w} = (x_{w}+ offX) >> 10;
Frac_x_{w} = ((x_{w}+ offX) >> 6) & 15;
Clip Int_x_{w} to [0,picture width]
for (j = 0; j < height; j++)
{

yⱼ = y₀ + j*stepY;
Int_yⱼ = (yⱼ + offY) >> 10;
Frac_yⱼ = ((yⱼ + offY) >> 6) & 15;
Clip Int_yⱼ to [0, picture height]

}

In some embodiments, the clip operation (represented as pseudo code “Clip”) in the above pseudo codes can be skipped or omitted. For an extended sample (xᵢ, yⱼ), the nearest integer reference samples corresponding to (xᵢ, yⱼ) can be (Int_xᵢ+(Frac_xᵢ>>3), Int_yⱼ+(Frac_yⱼ>>3). Assuming the integer sample used for gradient calculation is (xᵢ, yⱼ), then they can be determined based on the following pseudo codes:

xi=clip Int_xi+(Frac_xi>>3) to [Int_x0−((tap_num>>1)−1),Int_xw−1+((tap_num>>1)]

yj=Clip Int_yj to [Int_y0−((tap_num>>1)−1),Int_yh−1+((tap_num>>1)]

In the above example embodiments described in association with FIG. 10, if the nearest integer reference samples are out of a reference sample area used for interpolating the prediction block, the nearest integer reference sample can be clipped within the reference sample area to avoid bandwidth increase. However, such a case can only occur when the resampling ratio (e.g., a scaling ratio) is large. Thus, in some embodiments, PROF can be enabled only when the resampling ratio is less than or equal to a threshold so that the nearest integer reference samples is guaranteed to be within the reference sample area, while PROF is disabled when the resampling ratio is greater than the threshold in order to avoid bandwidth increase.

In some embodiments, the threshold of the resampling ratio can depend on the number of interpolation filter taps used for prediction block interpolation. For example, if a 6-tap interpolation filter is used, 2 additional reference samples on the top and left and 3 additional reference samples on the bottom and right can be fetched, in which the threshold can be set to be 2. In such a case, if the resampling ratio is less than or equal to 2, PROF can be enabled; otherwise, PROF can be disabled for the current block. As another example, if an 8-tap interpolation filter is used, 3 additional reference samples on the top and left and 4 additional reference samples on the bottom and right can be fetched, in which the threshold can be set to be 3. In such a case, if the resampling ratio is less than or equal to 3, PROF can be enabled; otherwise, PROF can be disabled for the current block.

In some embodiments, the controlling of enabling PROF can be described as follows. Assuming the threshold of the resampling ratio is 2, the resampling ratio of the current block can be determined based on the following pseudo codes:

hori_scale_fp = ( ( fRefWidth << 14 ) + ( PicWidth >> 1 ) ) / PicWidth
vert_scale_fp = ( ( fRefHeight << 14 ) + ( PicHeight >> 1 ) ) / PicHeight

where fRefWidth and fRefHeight are respectively the width and height of reference picture of the current block, and PicOutputWidthL and PicOutputHeightL are respectively the width and height of the target picture. Whether to apply PROF based on hori_scale_fp and vert_scale_fp can be implemented using the following pseudo codes:

if (hori_scale_fp<= ((1<<14)<<1) && vert_scale_fp<= ((1<<14)<<1))

apply PROF on the current block

otherwise

not apply PORF on the current block

where (1<<14)<<1 in the above pseudo codes can be directly written as 1<<15. As described above, if PROF is determined to be applied for the current block, PROF can be applied to further refine the prediction block. If PROF is determined to be not applied, the prediction block is not refined by PROF.

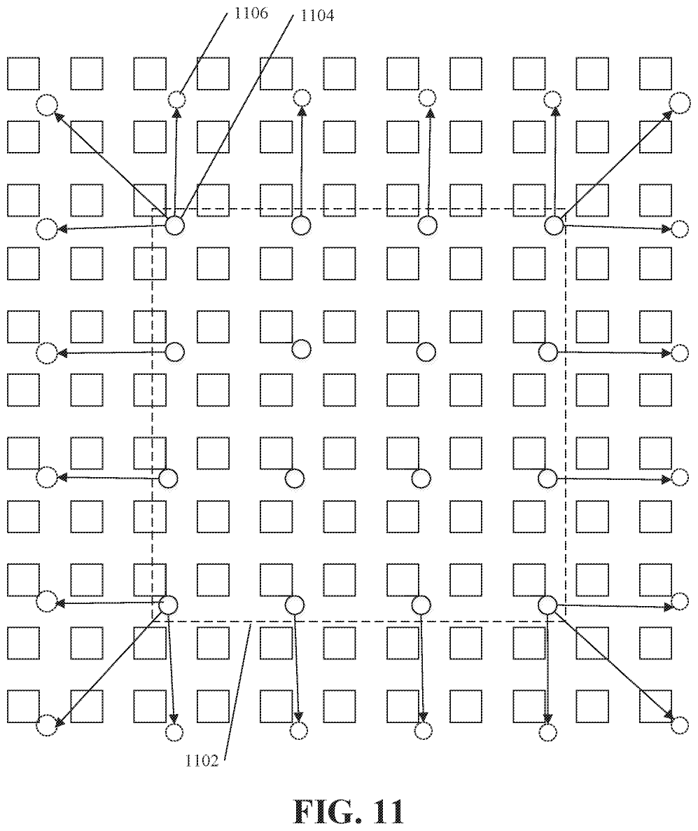

Consistent with some embodiments of this disclosure, the prediction block can be extended by copying the boundary samples to avoid bandwidth increase. FIG. 11 is a schematic diagram illustrating third example samples in gradient calculation, according to some embodiments of the present disclosure. In FIG. 11, a scaling ratio is 2. For example, a reference picture is twice of a target picture in horizontal and vertical dimensions.

In FIG. 11, the circles in solid lines represent 4×4 prediction blocks in the reference picture, the squares represent reference samples at integer positions, and the circles in dotted lines represent extended samples. Value of the extended samples can be directly copied from boundary prediction samples, which is illustrated by arrows in FIG. 11. In some embodiments, only the samples within the prediction block need to be interpolated, and the positions of the extended prediction samples can be directly copied from the prediction samples.

In some embodiments, let S[i][j] (i=0 . . . w−1, h=0 . . . h−1) be the prediction samples, and let S[i][−1] (i=−1 . . . w), S[i][h] (i=−1 . . . w), S[−1][j] (j=0 . . . h−1), and S[w][j] (j=0 . . . h−1) be the extended samples, where w and h are the width and the height of the prediction block, respectively. In such a case, extending the prediction samples by copying can be implemented based on the following pseudo codes:

S[−1][−1] = S[0][0]
S[w][−1] = S[w−1][0]
S[−1][h] = S[0][h−1]
S[w][h] = S[w−1][h−1]
S[i][−1] = S[i][0], for i = 0...w−1
S[i][h] = S[i][h−1], for i = 0...w−1
S[−1][j] = S[0][j], j = 0...h−1
S[w][j] = S[w−1][j], j = 0...h−1

In some embodiments, let (Gxᵢⱼ, Gyᵢⱼ) (i=0 . . . w−1, h=0 . . . h−1) be the gradient of prediction sample S[i][j], which can be described using the following embodiments as examples. In some embodiments, for all prediction samples, (Gxᵢⱼ, Gyᵢⱼ) can be calculated by subtracting the right neighboring sample and left neighboring sample (for horizontal gradient) or by subtracting the below neighboring sample and upper neighboring sample (for vertical gradient), such as:

(Gxᵢⱼ,Gyᵢⱼ)=(S[i+1][j]−S[i−1][j],S[i][j+1]−S[i][j−1]), for i=0 . . . w−1 j=0 . . . h−1

In some embodiments, for inner prediction samples, the gradient calculation of (Gxᵢⱼ, Gyᵢⱼ) can be the same as the above. For boundary prediction samples, (Gxᵢⱼ, Gyᵢⱼ) can be multiplied by 2 after calculation, such as being represented by the following pseudo codes:

(Gxᵢⱼ, Gyᵢⱼ) = (S[i+1][j] − S[i−1][j], S[i][j+1]−S[i][j−1]), for i = 1...w−2,j = 1...h−2
(Gxᵢ₀, Gyᵢ₀) = (S[i+1][0] − S[i−1][0], (S[i][ 1]−S[i][−1])<<1), for i = 1...w−2
(Gxᵢ₀, Gyᵢ₀) = ((S[i+1][0] − S[i−1][0])<<1, (S[i][ 1]−S[i][−1])<<1), for i = 0 or w−1
(Gxᵢₕ₋₁, Gyᵢₕ₋₁) = (S[i+1][h−1] − S[i−1][h−1], (S[i][ h]−S[i][h−2])<<1), for i = 1...w−2
(Gxᵢₕ₋₁, Gyᵢₕ₋₁) = ((S[i+1][h−1] − S[i−1][h−1])<<1, (S[i][ h]−S[i][h−2])<<1), for i = 0 or
w−1
(Gx₀ⱼ, Gy₀ⱼ) = ((S[1][j] − S[−1][j])<<1, S[0][j+1]−S[0][j−1]), for j = 1...h−2
(Gx_{w-1j}, Gy_{w-1j}) = ((S[w][j] − S[w−2][j])<<1, S[w−1][j+1]−S[w−1][j−1]), for j = 1...h−2

In some embodiments, for gradient calculation, another way can be used to extend the prediction block, in which an offset can be added to the value copied from the prediction block boundary sample. For example, the offset can be a difference between a boundary sample and an inner neighboring sample of the boundary sample. The extending process can be implemented based on the following pseudo codes:

S[i][−1] = S[i][0]+(S[i][0]−S[i][1]) = (S[i][0]<<1)−S[i][1], for i = 0...w−1
S[i][h] = S[i][h−1]+(S[i][h−1]−S[i][h−2]) = (S[i][h−1]<<l)−S[i][h−2], for i = 0...w−1
S[−1][j] = S[0][j]+(S[0][j]−S[1][j]) = (S[0][j]<<1)−S[1][j], j = 0...h−1
S[w][j] = S[w−1]+(S[w−1]−S[w−2]) = (S[w−1][j]<<1)−S[w−2][j], j = 0...h−1

After extending the prediction block, (Gxᵢⱼ, Gyᵢⱼ) can be calculated based on:

(Gxᵢⱼ,Gyᵢⱼ)=(S[i+1][j]−S[i−1][j],S[i][j+1]−S[i][j−1]), for i=0 . . . w−1,j=0 . . . h−1

Consistent with some embodiments of this disclosure, a prediction block can be not extended to avoid the memory access bandwidth increase. In those cases, only gradients of inner prediction samples are calculated, while gradients of boundary prediction samples can be directly copied from that of the inner prediction samples.

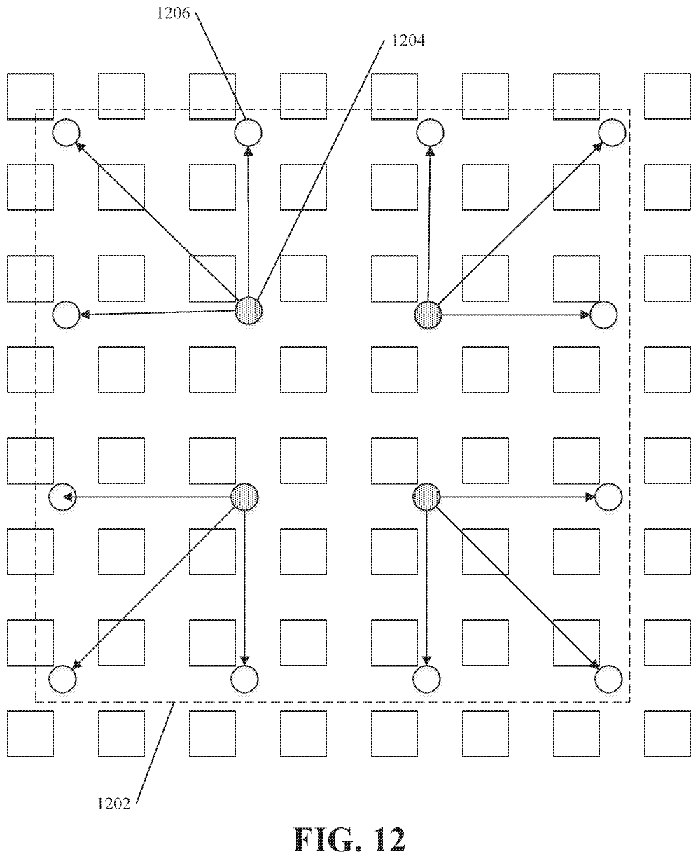

FIG. 12 is a schematic diagram illustrating fourth example samples in gradient calculation, according to some embodiments of the present disclosure. In the example shown in FIG. 12, the scaling ratio is 2. For example, a reference picture is twice of a target picture in horizontal and vertical dimensions. In FIG. 12, the circles represent 4×4 prediction blocks in the reference picture, and the squares represent reference samples at integer positions. In some embodiments, only the gradient of inner prediction samples (represented as pattern-filled circles in FIG. 12) are calculated. Gradients of boundary prediction samples (represented as white circles) can be directly copied from that of the inner samples, which is illustrated as arrows in FIG. 12. By doing so, the prediction block is not extended, and no additional reference samples are required for interpolation.

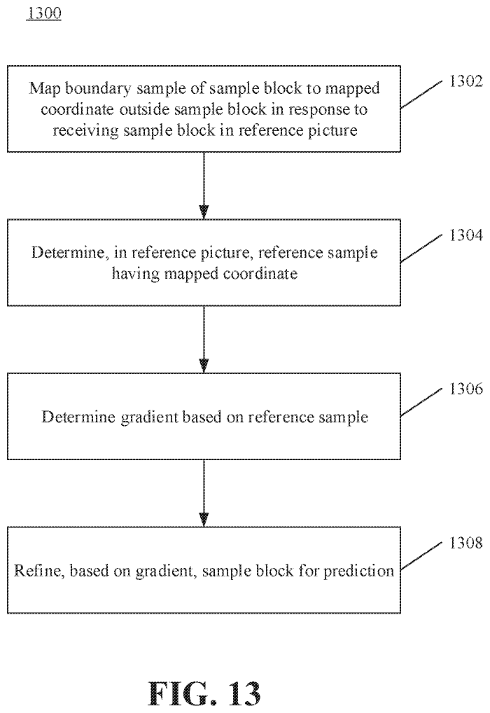

By way of example, FIG. 13 illustrates a flowchart of an example process 1300 for video processing, according to some embodiments of this disclosure. In some embodiments, process 1300 can be performed by a codec (e.g., an encoder in FIGS. 2A-2B or a decoder in FIGS. 3A-3B). For example, the codec can be implemented as one or more software or hardware components of an apparatus (e.g., apparatus 400) for controlling a coding mode of encoding or decoding a video sequence.

At step 1302, a processor can map a boundary sample of a sample block to a mapped coordinate outside the sample block in response to receiving the sample block in a reference picture. For example, the processor can be processor 402 in FIG. 4. In some embodiments, the sample block can be a luma block or a chroma block. The position can be represented as a set of coordinates and stored as a data structure (e.g., an array, a vector, a matrix, or any organized computer data structure). The reference picture can be from a video sequence (e.g., video sequence 202 in process 200A or 200B in FIGS. 2A-2B). For example, the sample block can be a sample block 902 (represented as a dashed-line box) in FIG. 9, which includes 16 samples (represented as white circles).

In some embodiments, to map the boundary sample to the mapped coordinate, the processor can determine a scaling factor using a dimension of the reference picture and a dimension of a target picture. For example, the processor can receive the dimension of the reference picture and the dimension of the target picture. The dimension of the reference picture can be the width or the height of the reference picture. The dimension of the target picture can be the width or the height of the target picture. The scaling factor can be any number. For example, the scaling factor can be hori_scale_fp or vert_scale_fp as described in association with FIGS. 9-12. After determining the scaling factor, the processor can determine a step size using the scaling factor. For example, the step size can be stepX or stepY as described in association with FIGS. 9-12. Then, the processor can map the boundary sample (e.g., a white circle at a boundary of sample block 902 in FIG. 9, such as boundary sample 904) to a position (e.g., a position of dotted circle 906 in FIG. 9) outside the sample block based on the step size. For example, the processor can map the boundary sample by adjusting a coordinate of the boundary sample using the step size in accordance with the pseudo codes as described in association with FIGS. 9-12. After that, the processor can determine the mapped coordinate as a coordinate in the reference picture having an integer coordinate nearest to the position. For example, the mapped coordinate having the integer coordinate nearest to the position can be a shaded square 908 nearest to dotted circle 906 in FIG. 9.

In some embodiments, after mapping the boundary sample (e.g., boundary sample 1004 in FIG. 10) to the mapped coordinate (e.g., shaded square 1006 in FIG. 10), the processor can determine whether the mapped coordinate is outside a predetermined block (e.g., box 1002 in FIG. 10) enclosing the sample block (e.g., sample block 1008 in FIG. 10). If the mapped coordinate is outside the predetermined block, the processor can determine a clipped coordinate (e.g., dotted square 1010 in FIG. 10) as an integer coordinate nearest to (e.g., represented by an arrow connected shaded square 1006 and dotted square 1010 in FIG. 10) the mapped coordinate and within the predetermined block (e.g., box 1002). After determining the clipped coordinate, the processor can update the mapped coordinate as the clipped coordinate. In some embodiments, the processor can determine the predetermined block based on a number of taps of an interpolation filter for interpolating a sample in the reference picture having a non-integer coordinate.

Still referring to FIG. 13, at step 1304, the processor can determine a reference sample (e.g., the integer sample as described in step 1302) having the mapped coordinate in the reference picture. At step 1306, the processor can determine a gradient based on the reference sample. For example, the gradient can be the Gxᵢⱼ or Gyᵢⱼ as described in association with FIGS. 9-12. In some embodiments, the processor can determine a gradient associated with the dimension using the integer reference coordinate for applying the PROF to the sample block. For example, the gradient can be different from the gradient and can be the Gxᵢⱼ or Gyᵢⱼ as described in association with FIGS. 9-12. At step 1308, the processor can refine the sample block for prediction based on the gradient. For example, the processor can refine the sample block by applying prediction refinement with optical flow (PROF) to the sample block based on the gradient.

Consistent with some embodiments of this disclosure, the processor can perform process 1300 to multiple boundary samples of the sample block. For example, the processor can map a plurality of boundary samples (e.g., the 12 boundary samples represented as white circles in sample block 902 of FIG. 9) of the sample block (sample block 902 of FIG. 9) to a plurality of mapped coordinates enclosing the sample block. For example, the plurality of mapped coordinates can be the coordinates of the dotted circles enclosing sample block 902 in FIG. 9. The processor can then determine a plurality of reference samples (e.g., multiple integer samples) having the plurality of mapped coordinates. The processor can further determine a plurality of gradients based on the plurality of reference samples and refine the sample block for prediction based on the plurality of gradients.

In some embodiments, the processor can determine the plurality of reference samples by copying values of the plurality of boundary samples to a plurality of positions having the plurality of mapped coordinate. Each of the plurality of boundary samples can correspond to at least one of the plurality of positions. For example, as illustrated in FIG. 11, a sample block 1102 (represented as a dashed-line box) can include 16 samples (represented as white circles). The processor can determine the reference samples by copying values of the boundary samples (e.g., the 12 boundary samples) of sample block 1102 to positions (e.g., positions represented as dotted circles in FIG. 11) having the mapped coordinate. The corresponding relationship of the boundary samples and the positions can be illustrated as the arrows in FIG. 11. In some embodiments, the plurality of positions can form a rectangle enclosing the sample block. For example, as illustrated in FIG. 11, the positions (represented as dotted circles) can form a rectangle enclosing sample block 1102.

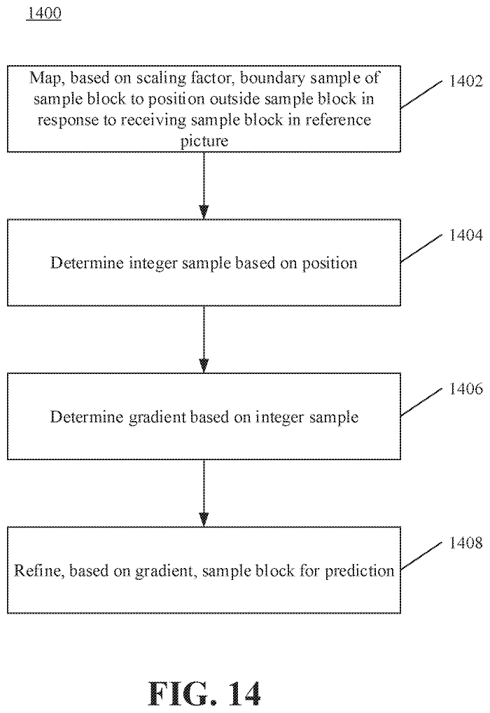

By way of example, FIG. 14 illustrates a flowchart of an example process 1400 for video processing, according to some embodiments of this disclosure. In some embodiments, process 1400 can be performed by a codec (e.g., an encoder in FIGS. 2A-2B or a decoder in FIGS. 3A-3B). For example, the codec can be implemented as one or more software or hardware components of an apparatus (e.g., apparatus 400) for controlling a coding mode of encoding or decoding a video sequence.

At step 1402, the processor can map a boundary sample of the sample block to a position outside the sample block based on a scaling factor in response to receiving a sample block in a reference picture. At step 1404, the processor can determine an integer sample based on the position. At step 1406, the processor can determine a gradient based on the integer sample. At step 1408, the processor can refine the sample block for prediction based on the gradient.

For example, process 1400 can be illustrated in association with FIG. 9. After receiving sample block 902, the processor can map a boundary sample (e.g., boundary sample 904) to a position (e.g., dotted circle 904) outside sample block 902 based on a scaling factor. For example, the scaling factor can be hori_scale_fp or vert_scale_fp as described in association with FIGS. 9-12. The processor can then determine an integer sample (shaded square 908). The processor can then determine the gradient based on the integer sample and refine sample block 902 for prediction based on the gradient.

In some embodiments, as illustrated in FIG. 10, the processor can clip the integer sample that is outside of a predetermined block. For example, the processor can determine whether the integer sample (e.g., shaded square 1006) is outside a predetermined block (e.g., box 1002) enclosing the sample block 1008. If the integer sample is outside the predetermined block, the processor can map the integer sample to a clipped position (e.g., dotted square 1010), in which the clipped position has an integer coordinate nearest to the integer sample and within the predetermined block. The processor can further update the integer sample as a sample at the clipped position.

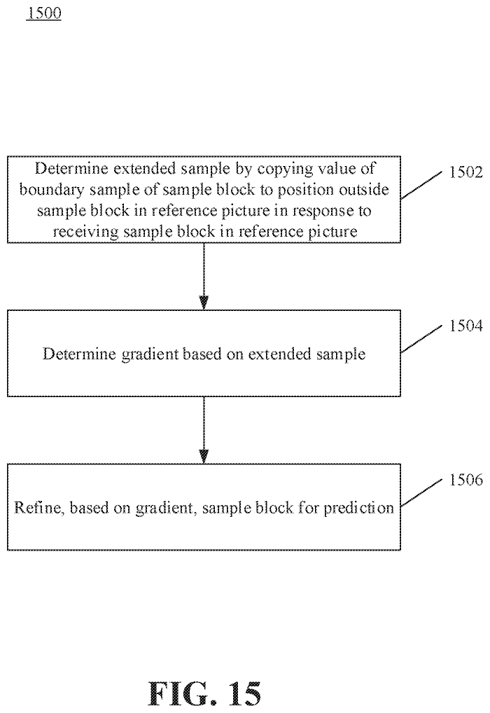

By way of example, FIG. 15 illustrates a flowchart of an example process 1500 for video processing, according to some embodiments of this disclosure. In some embodiments, process 1500 can be performed by a codec (e.g., an encoder in FIGS. 2A-2B or a decoder in FIGS. 3A-3B). For example, the codec can be implemented as one or more software or hardware components of an apparatus (e.g., apparatus 400) for controlling a coding mode of encoding or decoding a video sequence.

At step 1502, the processor can determine an extended sample by copying a value of a boundary sample of the sample block to a position outside the sample block in the reference picture in response to receiving a sample block in a reference picture. At step 1504, the processor can determine a gradient based on the extended sample. At step 1506, the processor can refine the sample block for prediction based on the gradient.

For example, process 1500 can be illustrated in association with FIG. 11. After receiving sample block 1102, the processor can determine an extended sample by copying a value of a boundary sample 1104 to a position (e.g., dotted circle 1106) outside sample block 1102. The processor can determine a gradient based on the extended example and refine sample block 1102 for prediction based on the gradient. As illustrated in FIG. 11, in some embodiments, the processor can determine the multiple extended samples by copying values of multiple boundary samples (e.g., including boundary sample 1104) to multiple positions (e.g., represented by the dotted circles including dotted circle 1106) enclosing sample block 1102. The multiple positions can form a rectangle enclosing sample block 1102.

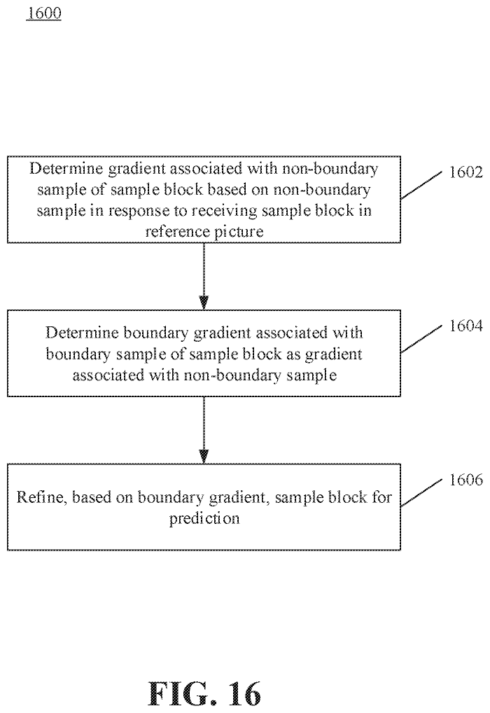

By way of example, FIG. 16 illustrates a flowchart of an example process 1600 for video processing, according to some embodiments of this disclosure. In some embodiments, process 1600 can be performed by a codec (e.g., an encoder in FIGS. 2A-2B or a decoder in FIGS. 3A-3B). For example, the codec can be implemented as one or more software or hardware components of an apparatus (e.g., apparatus 400) for controlling a coding mode of encoding or decoding a video sequence.

At step 1602, the processor can determine a gradient associated with a non-boundary sample of the sample block based on the non-boundary sample in response to receiving a sample block in a reference picture. At step 1604, the processor can determine a boundary gradient associated with a boundary sample of the sample block as the gradient. At step 1606, the processor can refine the sample block for prediction based on the boundary gradient.

For example, process 1600 can be illustrated in association with FIG. 12. After receiving sample block 1202, the processor can determine a gradient associated with a non-boundary sample 1204 based on itself. For example, non-boundary block 1204 can be an inner prediction sample as described in association with FIGS. 9-12. The gradient associated with non-boundary block 1204 can be associated with a dimension of the target picture or a dimension of the reference picture. Then, the processor can determine a boundary gradient associated with a boundary sample 1206 as the gradient associated with non-boundary sample 1204. The processor can further refine sample block 1202 for prediction based on the boundary gradient. It can be seen in FIG. 12 that, in some embodiments, multiple boundary samples (e.g., the white circles including boundary sample 1206) can form a rectangle enclosing multiple non-boundary samples (e.g., including non-boundary sample 1204).

In some embodiments, a non-transitory computer-readable storage medium including instructions is also provided, and the instructions can be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device can include one or more processors (CPUs), an input/output interface, a network interface, and/or a memory.

The embodiments can further be described using the following clauses:
1. A non-transitory computer-readable medium storing a set of instructions that is executable by at least one processor of an apparatus to cause the apparatus to perform a method, the method comprising:
in response to receiving a sample block in a reference picture, mapping a boundary sample of the sample block to a mapped coordinate outside the sample block;
determining, in the reference picture, a reference sample including the mapped coordinate;
determining a gradient based on the reference sample; and
refining, based on the gradient, the sample block for prediction.
2. The non-transitory computer-readable medium of clause 1, wherein the set of instructions that is executable by the at least one processor of the apparatus causes the apparatus to further perform:
mapping a plurality of boundary samples of the sample block to a plurality of mapped coordinates enclosing the sample block;
determining a plurality of reference samples having the plurality of mapped coordinates;
determining a plurality of gradients based on the plurality of reference samples; and
refining, based on the plurality of gradients, the sample block for prediction.
3. The non-transitory computer-readable medium of clause 2, wherein determining the plurality of reference samples having the plurality of mapped coordinates comprises:
determining the plurality of reference samples by copying values of the plurality of boundary samples to a plurality of positions having the plurality of mapped coordinate, wherein each of the plurality of boundary samples corresponds to at least one of the plurality of positions.
4. The non-transitory computer-readable medium of clause 3, wherein the plurality of positions forms a rectangle enclosing the sample block.
5. The non-transitory computer-readable medium of any of clauses 1-4, wherein mapping the boundary sample to the mapped coordinate comprises:
determining a scaling factor using a dimension of the reference picture and a dimension of a target picture;
determining a step size using the scaling factor;
mapping the boundary sample to a position outside the sample block based on the step size; and
determining the mapped coordinate as a coordinate in the reference picture having an integer coordinate nearest to the position.
6. The non-transitory computer-readable medium of clause 5, wherein the set of instructions that is executable by the at least one processor of the apparatus causes the apparatus to further perform:
determining whether the mapped coordinate is outside a predetermined block enclosing the sample block;
based on a determination that the mapped coordinate is outside the predetermined block, determining a clipped coordinate as an integer coordinate nearest to the mapped coordinate and within the predetermined block; and
updating the mapped coordinate as the clipped coordinate.
7. The non-transitory computer-readable medium of clause 6, wherein the set of instructions that is executable by the at least one processor of the apparatus causes the apparatus to further perform:
determining the predetermined block based on a number of taps of an interpolation filter for interpolating a sample in the reference picture having a non-integer coordinate.
8. The non-transitory computer-readable medium of any of clauses 1-7, wherein the sample block is a luma block or a chroma block.
9. An apparatus, comprising:
a memory configured to store a set of instructions; and
one or more processors communicatively coupled to the memory and configured to execute the set of instructions to cause the apparatus to perform:
in response to receiving a sample block in a reference picture, mapping a boundary sample of the sample block to a mapped coordinate outside the sample block;
determining, in the reference picture, a reference sample having the mapped coordinate;
determining a gradient based on the reference sample; and
refining, based on the gradient, the sample block for prediction.
10. The apparatus of clause 9, wherein the one or more processors are further configured to execute the set of instructions to cause the apparatus to perform:
mapping a plurality of boundary samples of the sample block to a plurality of mapped coordinates enclosing the sample block;
determining a plurality of reference samples having the plurality of mapped coordinates;
determining a plurality of gradients based on the plurality of reference samples; and
refining, based on the plurality of gradients, the sample block for prediction.
11. The apparatus of clause 10, wherein determining the plurality of reference samples having the plurality of mapped coordinates comprises:
determining the plurality of reference samples by copying values of the plurality of boundary samples to a plurality of positions having the plurality of mapped coordinate, wherein each of the plurality of boundary samples corresponds to at least one of the plurality of positions.
12. The apparatus of clause 11, wherein the plurality of positions forms a rectangle enclosing the sample block.
13. The apparatus of any of clauses 9-12, wherein mapping the coordinate of the boundary sample to the mapped coordinate comprises:
determining a scaling factor using a dimension of the reference picture and a dimension of a target picture;
determining a step size using the scaling factor;
mapping, based on the step size, the boundary sample to a position outside the sample block; and
determining the mapped coordinate as a coordinate in the reference picture having an integer coordinate nearest to the position.
14. The apparatus of clause 13, wherein the one or more processors are further configured to execute the set of instructions to cause the apparatus to perform:
determining whether the mapped coordinate is outside a predetermined block enclosing the sample block;
based on a determination that the mapped coordinate is outside the predetermined block, determining a clipped coordinate as an integer coordinate nearest to the mapped coordinate and within the predetermined block; and
updating the mapped coordinate as the clipped coordinate.
15. The apparatus of clause 14, wherein the one or more processors are further configured to execute the set of instructions to cause the apparatus to perform:
determining the predetermined block based on a number of taps of an interpolation filter for interpolating a sample in the reference picture having a non-integer coordinate.
16. The apparatus of any of clauses 9-15, wherein the sample block is a luma block or a chroma block.
17. A computer-implemented method for video processing, comprising:
in response to receiving a sample block in a reference picture, mapping a boundary sample of the sample block to a mapped coordinate outside the sample block;
determining a reference sample having the mapped coordinate in the reference picture;
determining a gradient based on the reference sample; and
refining, based on the gradient, the sample block for prediction.
18. The computer-implemented method of clause 17, further comprising:
mapping a plurality of boundary samples of the sample block to a plurality of mapped coordinates enclosing the sample block;
determining a plurality of reference samples having the plurality of mapped coordinates;
determining a plurality of gradients based on the plurality of reference samples; and
refining, based on the plurality of gradients, the sample block for prediction.
19. The computer-implemented method of clause 18, wherein determining the plurality of reference samples having the plurality of mapped coordinates comprises:
determining the plurality of reference samples by copying values of the plurality of boundary samples to a plurality of positions having the plurality of mapped coordinate, wherein each of the plurality of boundary samples corresponds to at least one of the plurality of positions.
20. The computer-implemented method of clause 19, wherein the plurality of positions forms a rectangle enclosing the sample block.
21. The computer-implemented method of any of clauses 17-20, wherein mapping the coordinate of the boundary sample to the mapped coordinate comprises:
determining a scaling factor using a dimension of the reference picture and a dimension of a target picture;
determining a step size using the scaling factor;
mapping, based on the step size, the boundary sample to a position outside the sample block; and
determining the mapped coordinate as a coordinate in the reference picture having an integer coordinate nearest to the position.
22. The computer-implemented method of clause 21, further comprising:
determining whether the mapped coordinate is outside a predetermined block enclosing the sample block;
based on a determination that the mapped coordinate is outside the predetermined block, determining a clipped coordinate as an integer coordinate nearest to the mapped coordinate and within the predetermined block; and
updating the mapped coordinate as the clipped coordinate.
23. The computer-implemented method of clause 22, further comprising:
determining the predetermined block based on a number of taps of an interpolation filter for interpolating a sample in the reference picture having a non-integer coordinate.
24. The computer-implemented method of any of clauses 17-23, wherein the sample block is a luma block or a chroma block.
25. A non-transitory computer-readable medium storing a set of instructions that is executable by at least one processor of an apparatus to cause the apparatus to perform a method, the method comprising:
in response to receiving a sample block in a reference picture, mapping, based on a scaling factor, a boundary sample of the sample block to a position outside the sample block;
determining an integer sample based on the position;
determining a gradient based on the integer sample; and
refining, based on the gradient, the sample block for prediction.
26. The non-transitory computer-readable medium of clause 25, wherein the set of instructions that is executable by the at least one processor of the apparatus causes the apparatus to further perform:
determining the scale factor using a dimension of a target picture and a dimension of the reference picture;
determining a step size using the scaling factor; and
mapping a coordinate of the boundary sample to a mapped coordinate using the coordinate and the step size.
27. The non-transitory computer-readable medium of any of clauses 25-26, wherein determining the integer sample based on the position comprises:
determining the integer sample as a sample in the reference picture having an integer coordinate nearest to the position.
28. The non-transitory computer-readable medium of any of clauses 25-27, wherein determining the gradient based on the integer sample comprises:
mapping a plurality of boundary samples of the sample block to a plurality of positions enclosing the sample block;
determining, based on the plurality of positions, a plurality of integer samples enclosing the sample block; and
determining a plurality of gradients based on the plurality of integer samples and the sample block.
29. The non-transitory computer-readable medium of any of clauses 25-28, wherein determining the integer sample based on the position comprises:
determining whether the integer sample is outside a predetermined block enclosing the sample block;
based on a determination that the integer sample is outside the predetermined block, mapping the integer sample to a clipped position, wherein the clipped position has an integer coordinate nearest to the integer sample and within the predetermined block; and
updating the integer sample as a sample at the clipped position.
30. The non-transitory computer-readable medium of clause 29, wherein the set of instructions that is executable by the at least one processor of the apparatus causes the apparatus to further perform:
determining the predetermined block based on a number of taps of an interpolation filter for interpolating a sample in the reference picture having a non-integer coordinate.
31. A non-transitory computer-readable medium storing a set of instructions that is executable by at least one processor of an apparatus to cause the apparatus to perform a method, the method comprising:
in response to receiving a sample block in a reference picture, determining an extended sample by copying a value of a boundary sample of the sample block to a position outside the sample block in the reference picture;
determining a gradient based on the extended sample; and
refining, based on the gradient, the sample block for prediction.
32. The non-transitory computer-readable medium of clause 31, wherein the set of instructions that is executable by the at least one processor of the apparatus causes the apparatus to further perform:
determining a plurality of extended samples by copying values of a plurality of boundary samples of the sample block to a plurality of positions enclosing the sample block;
determining a plurality of gradients based on the plurality of extended samples; and
refining, based on the plurality of gradients, the sample block for prediction.
33. The non-transitory computer-readable medium of clause 32, wherein the plurality of positions forms a rectangle enclosing the sample block.
34. A non-transitory computer-readable medium storing a set of instructions that is executable by at least one processor of an apparatus to cause the apparatus to perform a method, the method comprising:
in response to receiving a sample block in a reference picture, determining a gradient associated with a non-boundary sample of the sample block;
determining a boundary gradient associated with a boundary sample of the sample block as the gradient associated with the non-boundary sample; and
refining, based on the boundary gradient, the sample block for prediction.
35. The non-transitory computer-readable medium of clause 34, wherein the set of instructions that is executable by the at least one processor of the apparatus causes the apparatus to further perform:
determining a plurality of gradients associated with a plurality of non-boundary samples of the sample block;
determining a plurality of boundary gradients associated with a plurality of boundary samples of the sample block as the plurality of gradients; and
refining, based on the plurality of gradients, the sample block for prediction.
36. The non-transitory computer-readable medium of clause 35, wherein the plurality of boundary samples forms a rectangle enclosing the plurality of non-boundary samples.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a component can include A or B, then, unless specifically stated otherwise or infeasible, the component can include A, or B, or A and B. As a second example, if it is stated that a component can include A, B, or C, then, unless specifically stated otherwise or infeasible, the component can include A, or B, or C, or A and B, or A and C, or B and C, or A and B and C.

It is appreciated that the above described embodiments can be implemented by hardware, or software (program codes), or a combination of hardware and software. If implemented by software, it can be stored in the above-described computer-readable media. The software, when executed by the processor can perform the disclosed methods. The computing units and other functional units described in the present disclosure can be implemented by hardware, or software, or a combination of hardware and software. One of ordinary skill in the art can also understand that multiple ones of the above described modules/units can be combined as one module/unit, and each of the above described modules/units can be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as example only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed example embodiments. However, many variations and modifications can be made to these embodiments. Accordingly, although specific terms are employed, they are used in a generic and descriptive sense only and not for purposes of limitation.

What is claimed is:

1. A non-transitory computer-readable medium storing a set of instructions that is executable by at least one processor of an apparatus to cause the apparatus to perform a method, the method comprising:
in response to receiving a sample block in a reference picture, mapping a boundary sample of the sample block to a mapped coordinate outside the sample block;
determining, in the reference picture, a reference sample including the mapped coordinate;
determining a gradient based on the reference sample; and
refining, based on the gradient, the sample block for prediction.

2. The non-transitory computer-readable medium of claim 1, wherein the set of instructions that is executable by the at least one processor of the apparatus causes the apparatus to further perform:
mapping a plurality of boundary samples of the sample block to a plurality of mapped coordinates enclosing the sample block;
determining a plurality of reference samples having the plurality of mapped coordinates;
determining a plurality of gradients based on the plurality of reference samples; and
refining, based on the plurality of gradients, the sample block for prediction.

3. The non-transitory computer-readable medium of claim 2, wherein determining the plurality of reference samples having the plurality of mapped coordinates comprises:
determining the plurality of reference samples by copying values of the plurality of boundary samples to a plurality of positions having the plurality of mapped coordinate, wherein each of the plurality of boundary samples corresponds to at least one of the plurality of positions.

4. The non-transitory computer-readable medium of claim 3, wherein the plurality of positions forms a rectangle enclosing the sample block.

5. The non-transitory computer-readable medium of claim 1, wherein mapping the boundary sample to the mapped coordinate comprises:
determining a scaling factor using a dimension of the reference picture and a dimension of a target picture;
determining a step size using the scaling factor;
mapping the boundary sample to a position outside the sample block based on the step size; and
determining the mapped coordinate as a coordinate in the reference picture having an integer coordinate nearest to the position.

6. The non-transitory computer-readable medium of claim 5, wherein the set of instructions that is executable by the at least one processor of the apparatus causes the apparatus to further perform:
determining whether the mapped coordinate is outside a predetermined block enclosing the sample block;
based on a determination that the mapped coordinate is outside the predetermined block, determining a clipped coordinate as an integer coordinate nearest to the mapped coordinate and within the predetermined block; and
updating the mapped coordinate as the clipped coordinate.

7. The non-transitory computer-readable medium of claim 6, wherein the set of instructions that is executable by the at least one processor of the apparatus causes the apparatus to further perform:
determining the predetermined block based on a number of taps of an interpolation filter for interpolating a sample in the reference picture having a non-integer coordinate.

8. The non-transitory computer-readable medium of claim 1, wherein the sample block is a luma block or a chroma block.

9. An apparatus, comprising:
a memory configured to store a set of instructions; and
one or more processors communicatively coupled to the memory and configured to execute the set of instructions to cause the apparatus to perform:
in response to receiving a sample block in a reference picture, mapping a boundary sample of the sample block to a mapped coordinate outside the sample block;
determining, in the reference picture, a reference sample having the mapped coordinate;
determining a gradient based on the reference sample; and
refining, based on the gradient, the sample block for prediction.

10. The apparatus of claim 9, wherein the one or more processors are further configured to execute the set of instructions to cause the apparatus to perform:
mapping a plurality of boundary samples of the sample block to a plurality of mapped coordinates enclosing the sample block;
determining a plurality of reference samples having the plurality of mapped coordinates;
determining a plurality of gradients based on the plurality of reference samples; and
refining, based on the plurality of gradients, the sample block for prediction.

11. The apparatus of claim 10, wherein determining the plurality of reference samples having the plurality of mapped coordinates comprises:
determining the plurality of reference samples by copying values of the plurality of boundary samples to a plurality of positions having the plurality of mapped coordinate, wherein each of the plurality of boundary samples corresponds to at least one of the plurality of positions.

12. The apparatus of claim 11, wherein the plurality of positions forms a rectangle enclosing the sample block.

13. The apparatus of claim 9, wherein mapping the coordinate of the boundary sample to the mapped coordinate comprises:
determining a scaling factor using a dimension of the reference picture and a dimension of a target picture;
determining a step size using the scaling factor:
mapping, based on the step size, the boundary sample to a position outside the sample block; and
determining the mapped coordinate as a coordinate in the reference picture having an integer coordinate nearest to the position.

14. The apparatus of claim 13, wherein the one or more processors are further configured to execute the set of instructions to cause the apparatus to perform:
determining whether the mapped coordinate is outside a predetermined block enclosing the sample block;
based on a determination that the mapped coordinate is outside the predetermined block, determining a clipped coordinate as an integer coordinate nearest to the mapped coordinate and within the predetermined block; and
updating the mapped coordinate as the clipped coordinate.

15. The apparatus of claim 14, wherein the one or more processors are further configured to execute the set of instructions to cause the apparatus to perform:
determining the predetermined block based on a number of taps of an interpolation filter for interpolating a sample in the reference picture having a non-integer coordinate.

16. The apparatus of claim 9, wherein the sample block is a luma block or a chroma block.

17. A non-transitory computer-readable medium storing a set of instructions that is executable by at least one processor of an apparatus to cause the apparatus to perform a method, the method comprising:
in response to receiving a sample block in a reference picture, determining a gradient associated with a non-boundary sample of the sample block;
determining a boundary gradient associated with a boundary sample of the sample block as the gradient associated with the non-boundary sample; and
refining, based on the boundary gradient, the sample block for prediction.

18. The non-transitory computer-readable medium of claim 17, wherein the set of instructions that is executable by the at least one processor of the apparatus causes the apparatus to further perform:
determining a plurality of gradients associated with a plurality of non-boundary samples of the sample block;
determining a plurality of boundary gradients associated with a plurality of boundary samples of the sample block as the plurality of gradients; and
refining, based on the plurality of gradients, the sample block for prediction.

19. The non-transitory computer-readable medium of claim 18, wherein the plurality of boundary samples forms a rectangle enclosing the plurality of non-boundary samples.

20. A computer-implemented method for video processing, comprising:
in response to receiving a sample block in a reference picture, mapping a boundary sample of the sample block to a mapped coordinate outside the sample block;
determining a reference sample having the mapped coordinate in the reference picture;
determining a gradient based on the reference sample; and
refining, based on the gradient, the sample block for prediction.
